(19) United States
(12) Patent Application Publication
(10) Pub. No.: US 2023/0074229 A1
(43) Pub. Date: Mar. 9, 2023

(54) SCALABLE ARRAY ARCHITECTURE FOR IN-MEMORY COMPUTING

(71) Applicant: The Trustees of Princeton University, Princeton, NJ (US)

(72) Inventors: Hongyang JIA, Princeton, NJ (US); Murat OZATAY, Plainsboro, NJ (US); Hossein VALAVI, Franklin Park, NJ (US); Naveen VERMA, Princeton, NJ (US)

(73) Assignee: The Trustees of Princeton University, Princeton, NJ (US)

(21) Appl. No.: 17/797,833

(22) PCT Filed: Feb. 5, 2021
(86) PCT No.: PCT/US2021/016734

§ 371 Date: Aug. 5, 2022

Related U.S. Application Data
(60) Provisional application No. 62/970,309, filed on Feb. 5, 2020.

(51) Int. Cl. G06F 3/06

(52) U.S. Cl. CPC G06F 3/0611; G06F 3/0673; G06F 3/0629; G06F 3/0659

(57) ABSTRACT

Various embodiments comprise systems, methods, architectures, mechanisms and apparatus for providing programmable or pre-programmed in-memory computing (IMC) operations via an array of configurable IMC cores interconnected by a configurable on-chip network to support scalable execution and dataflow of an application mapped thereto.

### CROSS-REFERENCE TO RELATED APPLICATION(S)

This application claims the benefit of U.S. Provisional Patent Application Ser. No. 62/970,309 filed Feb. 5, 2020, which Application is incorporated herein by reference in its entirety.

### GOVERNMENT SUPPORT

This invention was made with government support under Contract No. NRO000-19-C-0014 awarded by U.S. Department of Defense. The government has certain rights in the invention.

### FIELD OF THE DISCLOSURE

The present disclosure generally relates to the field of in-memory computing and matrix-vector multiplication.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Deep-learning inference, based on neural networks (NNs), is being deployed in a broad range of applications. This is motivated by breakthrough performance in cognitive tasks. But, it has driven increasing complexity (number of layers, channels) and diversity (network architectures, internal variables/representations) of NNs, necessitating hardware acceleration for energy efficiency and throughput, yet via flexibly programmable architectures.

The dominant operation in NNs is matrix-vector multiplication (MVM), typically involving high-dimensionality matrices. This makes data storage and movement in an architecture the primary challenge. However, MVMs also present structured dataflow, motivating accelerator architectures where hardware is explicitly arranged accordingly, into two-dimensional arrays. Such architectures are referred to as spatial architectures, often employing systolic arrays where processing engines (PEs) perform simple operations (multiplication, addition) and pass outputs to adjacent PEs for further processing. Many variants have been reported, based on different ways of mapping the MVM computations and dataflow, and providing supports for different computational optimizations (e.g., sparsity, model compression).

An alternative architectural approach that has recently gained interest is in-memory computing (IMCs). IMC can also be viewed as a spatial architecture, but where the PEs are memory bit cells. IMC typically employs analog operation, both to fit computation functionality in constrained bit-cell circuits (i.e., for area efficiency) and to perform the computation with maximal energy efficiency. Recent demonstrations of NN accelerators based on IMC have achieved roughly 10× higher energy efficiency (TOPS/W) and 10× higher compute density (TOPS/mm2), simultaneously, compared to optimized digital accelerators.

While such gains make IMC attractive, the recent demonstrations have also exposed a number of critical challenges, primarily arising from analog non-idealities (variations, nonlinearity). First, most demonstrations are limited to small scale (less than 128 Kb). Second, use of advanced CMOS nodes is not demonstrated, where analog non-idealities are expected to worsen. Third, integration in larger computing systems (architectural and software stacks) is limited, due to difficulties in specifying functional abstractions of such analog operation.

Some recent works have begun to explore system integration. For instance, developed an ISA and provided interfaces to a domain-specific language; however, application mapping was restricted to small inference models and hardware architectures (single bank). Meanwhile, developed functional specifications for IMC operations; however, analog operation, necessary for highly parallel IMC over many rows, was avoided in favor of a digital form of IMC with reduced parallelism. Thus, analog non-idealities have largely blocked the full potential of IMC from being harnessed in scaled-up architectures for practical NNs.

### SUMMARY

Various deficiencies in the prior art are addressed by systems, methods, architectures, mechanisms or apparatus providing programmable or pre-programmed in-memory computing (IMC) operations via an array of configurable IMC cores interconnected by a configurable on-chip network to support scalable execution and dataflow of an application mapped thereto.

For example, various embodiments provide an integrated in-memory computing (IMC) architecture configurable to support scalable execution and dataflow of an application mapped thereto, the IMC architecture implemented on a semiconductor substrate and comprising an array of configurable IMC cores such as Compute-In-Memory Units (CIMUs) comprising IMC hardware and, optionally, other hardware such as digital computing hardware, buffers, control blocks, configuration registers, digital to analog converters (DACs), analog to digital converters (ADCs), and so on as will be described in more detail below.

The array of configurable IMC cores/CIMUs are interconnected via an on-chip network including inter-CIMU network portions or an on-chip network, and are configured to communicate input data and computed data (e.g., activations in a neural network embodiment) to/from other CIMUs or other structures within or outside the CIMU array via respective configurable inter-CIMU network portions disposed therebetween, and to communicate operand data (e.g., weights in a neural network embodiment) to/from other CIMUs or other structures within or outside the CIMU array via respective configurable operand loading network portions disposed therebetween.

Generally speaking, each of the IMC cores/CIMUs comprises a configurable input buffer for receiving computational data from an inter-CIMU network and composing the received computational data into an input vector for matrix vector multiplication (MVM) processing by the CIMU to generate thereby an output vector.

Some embodiments comprise a neural network (NN) accelerator having an array-based architecture, wherein a plurality of compute in memory units (CIMUs) are arrayed and interconnected using a very flexible on-chip network wherein the outputs of one CIMU may be connected to or flow to the inputs of another CIMU or to multiple other CIMUs, the outputs of many CIMUs may be connected to the inputs of one CIMU, the outputs of one CIMU may be connected to the outputs of another CIMU and so on. The on-chip network may be implemented as a single on-chip network, as a plurality of on-chip network portions, or as a combination of on-chip and off-chip network portions.

One embodiment provides an integrated in-memory computing (IMC) architecture configurable to support scalable execution and dataflow of an application mapped thereto, comprising: a plurality of configurable Compute-In-Memory Units (CIMUs) forming an array of CIMUs; and a configurable on-chip network for communicating input data to the array of CIMUs, communicating computed data between CIMUs, and communicating output data from the array of CIMUs.

One embodiment provides a computer implemented method of mapping an application to configurable in-memory computing (IMC) hardware of an integrated IMC architecture, the IMC hardware comprising a plurality of configurable Compute-In-Memory Units (CIMUs) forming an array of CIMUs, and a configurable on-chip network for communicating input data to the array of CIMUs, communicating computed data between CIMUs, and communicating output data from the array of CIMUs, the method comprising: allocating IMC hardware according to application computations, using parallelism and pipelining of IMC hardware, to generate an IMC hardware allocation configured to provide high throughput application computation; defining placement of allocated IMC hardware to locations in the array of CIMUs in a manner tending to minimize a distance between IMC hardware generating output data and IMC hardware processing the generated output data; and configuring the on-chip network to route the data between IMC hardware. The application may comprise a NN. The various steps may be implemented in accordance with the mapping techniques discussed throughout this application.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A-1B depict diagrammatic representations of a conventional memory accessing architecture and an In-Memory Computing (IMC) architecture useful in understanding the present embodiments;

FIG. 2A-2C depict diagrammatic representations of a high-SNR charge-domain SRAM IMC based on capacitors useful in understanding the present embodiments;

FIG. 3A schematically depicts a 3-bit binary input-vector and matrix element;

FIG. 3B depicts an image of realized heterogeneous microprocessor chip comprising an integration of a programmable heterogeneous architecture as well as software level interfaces;

FIG. 4A depicts a circuit diagram of an analog input voltage bit-cell suitable for use in various embodiments;

FIG. 4B depicts a circuit diagram of a multi-level driver suitable for providing analog input voltages to the analog-input bit cell of FIG. 4A;

FIG. 5 graphically depicts layer unrolling by mapping multiple NN layers such that a pipeline is effectively formed;

FIG. 6 graphically depicts pixel-level pipelining with input buffering of feature-map rows;

FIG. 7 graphically depicts replication for throughput matching in pixel-level pipelining;

FIG. 8A-8C depict diagrammatic representations of row underutilization and mechanisms to address row underutilization useful in understanding the various embodiments;

FIG. 9 graphically depicts a sample of the operations enabled by CIMU configurability via a software instruction library;

FIG. 10 graphically depicts architectural support for spatial mapping within application layers, such as NN layers;

FIG. 11 graphically depicts a method of mapping NN filters to IMC banks, with each bank having dimensionality of N rows and M columns, by loading filter weights in memory as matrix elements and applying input-activations as input-vector elements, to compute output pre-activations as output-vector elements;

FIG. 12 depicts a block diagram illustrating exemplary architectural support elements associated with IMC banks for layer and BPBS unrolling;

FIG. 13 depicts a block diagram illustrating an exemplary near-memory computation SIMD engine;

FIG. 14 depicts a diagrammatic representation of an exemplary LSTM layer mapping function exploiting cross-element near-memory computation

FIG. 15 graphically illustrates mapping of a BERT layer using generated data as a loaded matrix;

FIG. 16 depicts a high-level block diagram of a scalable NN accelerator architecture based on IMC in accordance with some embodiments;

FIG. 17 depicts a high-level block diagram of a CIMU microarchitecture with 1152×256 IMC bank suitable for use in the architecture of FIG. 16;

FIG. 18 depicts a high-level block diagram of a segment for taking inputs from a CIMU;

FIG. 19 depicts a high-level block diagram of a segment for providing outputs to a CIMU;

FIG. 20 depicts a high-level block diagram of an exemplary switch block for selecting which inputs are routed to which outputs;

FIG. 21A depicts a layout view of a CIMU architecture according to an embodiment implemented in a 16 nm CMOS technology, and FIG. 21B depicts a layout view of a full chip consisting of a 4×4 tiling of CIMUs such as provided in FIG. 21A;

FIG. 22 graphically depicts three stages of mapping software flow to an architecture, illustratively, a NN mapping flow being mapped onto an 8×8 array of CIMUs;

FIG. 23A depicts a sample placement of layers from a pipeline segment, and FIG. 23B depicts a sample routing from a pipeline segment;

FIG. 24 depicts a high-level block diagram of a computing device suitable for use in performing functions according to the various embodiments;

FIG. 25 depicts a typical structure of an in-memory computing architecture;

FIG. 26 depicts a high level block diagram of an exemplary architecture according to an embodiment;

FIG. 27 depicts a high level block diagram of an exemplary Compute-In-Memory-Unit (CIMU) suitable for use in the architecture of FIG. 26;

FIG. 28 depicts a high level block diagram of an Input-Activation Vector Reshaping Buffer (IA BUFF) according to an embodiment and suitable for use in the architecture of FIG. 2;

FIG. 29 depicts a high level block diagram of a CIMA Read/Write Buffer according to an embodiment and suitable for use in the architecture of FIG. 26;

FIG. 30 depicts a high level block diagram of a Near-Memory Datapath (NMD) Module according to an embodiment and suitable for use in the architecture of FIG. 26;

FIG. 31 depicts a high level block diagram of a direct memory access (DMA) module according to an embodiment and suitable for use in the architecture of FIG. 26;

FIGS. 32A-32B depict high level block diagrams of differing embodiments of CIMA channel digitization/weighting suitable for use in the architecture of FIG. 26;

FIG. 33 depicts a flow diagram of a method according to an embodiment; and

FIG. 34 depicts a flow diagram of a method according to an embodiment.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It must be noted that as used herein and in the appended claims, the singular forms “a”, “an”, and “the” include plural referents unless the context clearly dictates otherwise.

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The various embodiments described herein are primarily directed to systems, methods, architectures, mechanisms or apparatus providing programmable or pre-programmed in-memory computing (IMC) operations, as well as scalable dataflow architectures configured for in-memory computing.

For example, various embodiments provide an integrated in-memory computing (IMC) architecture configurable to support scalable execution and dataflow of an application mapped thereto, the IMC architecture implemented on a semiconductor substrate and comprising an array of configurable IMC cores such as Compute-In-Memory Units (CIMUs) comprising IMC hardware and, optionally, other hardware such as digital computing hardware, buffers, control blocks, configuration registers, digital to analog converters (DACs), analog to digital converters (ADCs), and so on as will be described in more detail below.

The array of configurable IMC cores/CIMUs are interconnected via an on-chip network including inter-CIMU network portions, and are configured to communicate input data and computed data (e.g., activations in a neural network embodiment) to/from other CIMUs or other structures within or outside the CIMU array via respective configurable inter-CIMU network portions disposed therebetween, and to communicate operand data (e.g., weights in a neural network embodiment) to/from other CIMUs or other structures within or outside the CIMU array via respective configurable operand loading network portions disposed therebetween.

Generally speaking, each of the IMC cores/CIMUs comprises a configurable input buffer for receiving computational data from an inter-CIMU network and composing the received computational data into an input vector for matrix vector multiplication (MVM) processing by the CIMU to generate thereby an output vector.

Additional embodiments described below are directed toward a scalable dataflow architecture for in-memory computing suitable for use independent of or in combination with the above-described embodiments

The various embodiments address analog nonidealities by moving to charge-domain operation wherein multiplications are digital but accumulation is analog, and is achieved by shorting together the charge from capacitors localized in the bit cells. These capacitors rely on geometric parameters, which are well controlled in advanced CMOS technologies, thus enabling much greater linearity and smaller variations (e.g., process, temperature) than semiconductor devices e.g., (transistors, resistive memory). This enables breakthrough scale (e.g., 2.4 Mb) of single-shot, fully-parallel IMC banks, as well as integration in larger computing systems (e.g., heterogeneous programmable architectures, software libraries), demonstrating practical NNs (e.g., 10 layers).

Improvements to these embodiments addresses architectural scale-up of IMC banks, as is required for maintaining high energy efficiency and throughput when executing state-of-the-art NNs. These improvements employ the demonstrated approach of charge-domain IMC to develop an architecture and associated mapping approaches for scaling-up IMC while maintaining such efficiency and throughput.

### Fundamental Tradeoffs of IMC

IMC derives energy-efficiency and throughput gains by performing analog computation and by amortizing the movement of raw data into movement of the computed result. This leads to fundamental tradeoffs, which ultimately shape the challenges in architectural scale-up and application mapping.

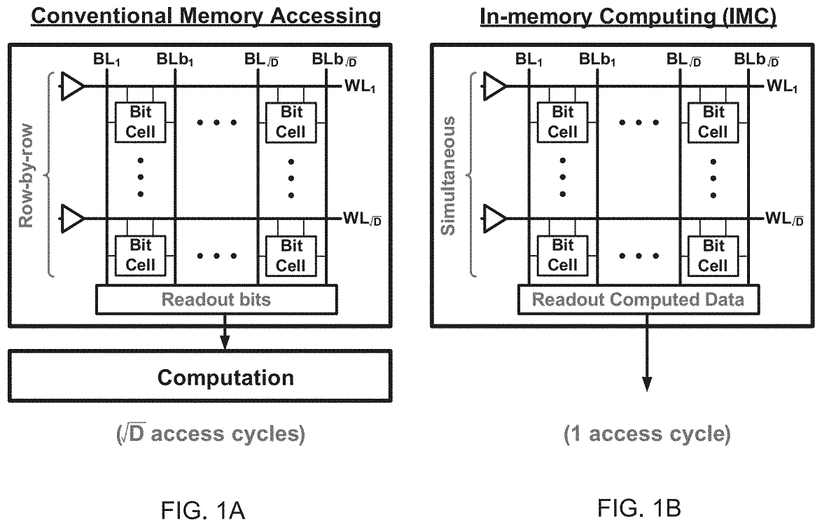

FIG. 1 depicts diagrammatic representations of a conventional memory accessing architecture and an In-Memory Computing (IMC) architecture useful in understanding the present embodiments. In particular, the diagrammatic representations of FIG. 1 illustrate the tradeoffs by first comparing IMC (FIG. 1B) to a conventional (digital) memory accessing architecture (FIG. 1A) that separates memory and computation, and then extending the intuition for comparison with a spatial digital architecture.

Consider an MVM computation involving D bits of data, stored in \sqrt{D}× \sqrt{D} bit cells. IMC takes input-vector data on word lines WL's all at once, performs multiplication with matrix-element data in bit cells, and performs accumulation on the bit lines BL/BLb's, thus giving output-vector data in one shot. In contrast, the conventional architecture requires \sqrt{D} access cycles to move the data to the point of computation outside the memory, thus incurring higher data-movement costs (energy, delay) on BL/BLb by a factor of \sqrt{D}. Since BL/BLb activity typically dominates in memories, IMC has the potential for energy-efficiency and throughput gains set by the level of row parallelism, up to \sqrt{D} (in practice, WL activity, which remains unchanged, is also a factor, but BL/BLb dominance provides substantial gains).

However, the critical tradeoff is that the conventional architecture accesses single-bit data on BL/BLb, while IMC accesses a computed result over \sqrt{D} bits of data. Generally, such a result can take on ˜\sqrt{D} levels of dynamic range. Thus, for fixed BL/BLb voltage swing and accessing noise, the overall signal-to-noise ratio (SNR), in terms of voltage, is reduced by a factor of \sqrt{D}. In practice, noise arises from non-idealities due to analog operation (variation, nonlinearity). Thus, SNR degradation opposes high row parallelism, limiting the achievable energy-efficiency and throughput gains.

Digital spatial architectures mitigate memory accessing and data movement by loading operands in PEs and exploiting opportunities for data reuse and short-distance communication (i.e., between PEs). Typically, computation costs of multiply-accumulate (MAC) operations dominate. IMC once again introduces an energy-efficiency and throughput versus SNR tradeoff. In this case, analog operation enables efficient MAC operations, but also raises the need for subsequent analog-to-digital conversion (ADC). On the one hand, a large number of analog MAC operations (i.e., high row parallelism) amortizes the ADC overheads; on the other hand, more MAC operations increase the analog dynamic range and degrades SNR.

The energy-efficiency and throughput versus SNR tradeoff has posed the primary limitation to scale-up and integration of IMC in computing systems. In terms of scale-up, eventually computation accuracy becomes intolerably low, limiting the energy/throughput gains that can be derived from row parallelism. In terms of integration in computing systems, noisy computation limits the ability to form robust abstractions required for architectural design and interfacing to software. Previous efforts around integration in computing systems have required restricting the row parallelism, to four rows or two rows. As described below, charge-domain analog operation has overcome this, leading to both substantial increase in row parallelism (4608 rows) and integration in a heterogeneous architecture. However, while such high levels of row parallelism are favorable for energy efficiency and throughput, they restrict hardware granularity for flexible mapping of NNs, necessitating specialized strategies explored in this work.

### High-SNR SRAM-Based Charge-Domain IMC

Rather than current-domain operation, where the bit-cell output signal is a current caused by modulating the resistance of an internal device, our previous work moves to charge-domain operation. Here, the bit-cell output signal is charge stored on a capacitor. While resistance depends on materials and device properties, which tend to exhibit substantial process and temperature variations, especially in advanced nodes, capacitance depends on geometric properties, which can be very well controlled in advanced CMOS technologies.

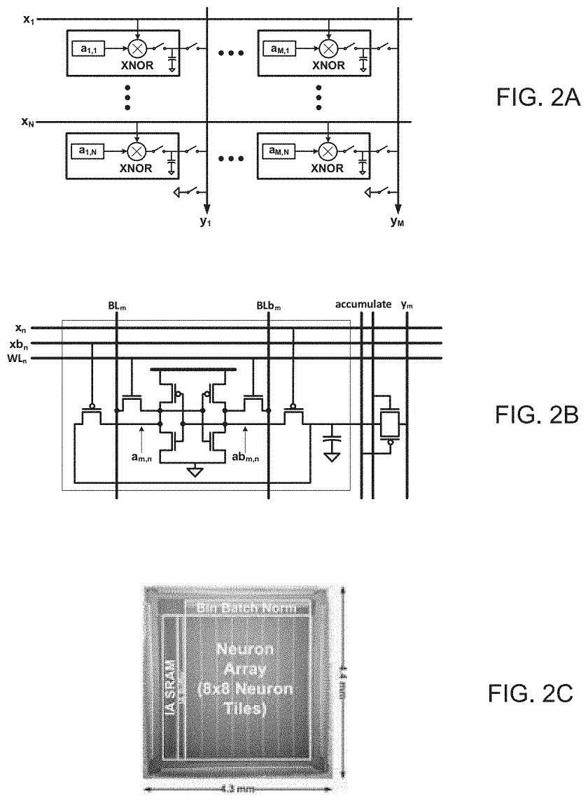

FIG. 2 depicts diagrammatic representations of a high-SNR charge-domain SRAM IMC based on capacitors useful in understanding the present embodiments. In particular, the diagrammatic representations of FIG. 2 illustrate a logical representation a charge-domain computation (FIG. 2A), a schematic representation of a bit cell (FIG. 2B), and an image of a realization of a 2.4 Mb integrated circuit (FIG. 2C).

FIG. 2A illustrates an approach to charge-domain computation. Each bit-cell takes binary input data xₙ/xbₙ, and performs multiplication with binary stored data a_{m,n}/ab_{m,n}. Treating the binary 0/1 data as −1/+1, this amounts to a digital XNOR operation. The binary output result is then stored as charge on a local capacitor. Then, accumulation is implemented by shorting together the charge from all bit-cell capacitors in a column, yielding the analog output yₘ. Digital binary multiplication avoids analog noise sources and ensures perfect linearity (two levels perfectly fit a line), while capacitor-based charge accumulation avoids noise due to excellent matching and temperature stability, and also ensures high linearity (intrinsic property of capacitors).

FIG. 2B illustrates a SRAM-based bit-cell circuit. Beyond the standard six transistors, two additional PMOS transistors are employed for XNOR-conditional capacitor charge-up, and two additional NMOS/PMOS transistors are employed outside the bit cell for charge accumulation (a single additional NMOS transistor is required for the entire column to pre-discharge all capacitors after accumulation). The extra bit-cell transistors impose a reported area overhead of 80%, while the local capacitor imposes no area overhead, as it is laid out using metal wiring above the bit cell. The dominant source of capacitor nonideality may be mismatch, which permits rows parallelism of over 100k before computation noise is comparable to the minimum analog signal separation. This enables the largest scale yet reported for IMC banks (2.4 Mb), overcoming a key limitation of the SNR tradeoff that has previously limited IMC (FIG. 2C).

While the charge-domain IMC operation involves binary input-vector and matrix elements, extends it to multi-bit elements.

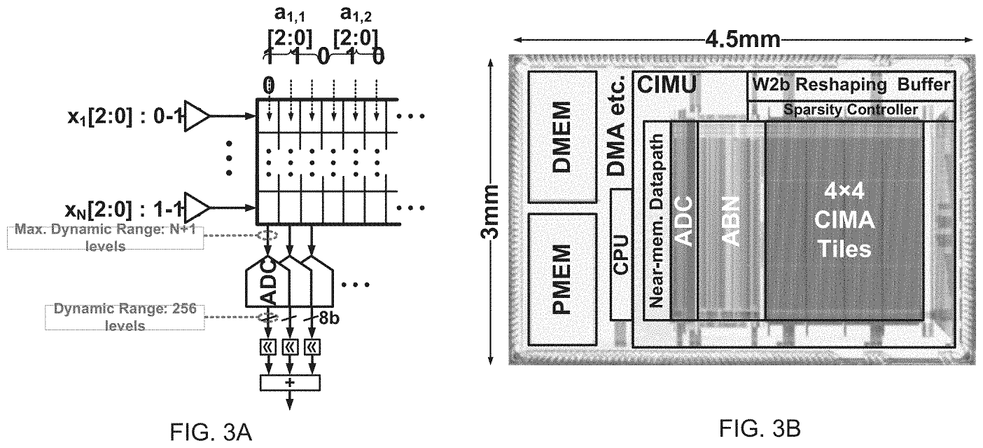

FIG. 3A schematically depicts a 3-bit binary input-vector and matrix element. This is achieved through bit-parallel/bit-serial (BPBS) computation. The multiple matrix-element bits are mapped to parallel columns, while the multiple input-vector elements are provided serially. Each of the column computations are then digitized using an 8-b ADC, chosen to balance energy and area overheads. The digitized column outputs are finally summed together after applying proper bit weighting (bit shifting) in the digital domain. The approach supports both two's-compliment number representation and a specialized number representation optimized for XNOR bit-wise computations.

Since the analog dynamic range of the column computation can be larger than the dynamic range supported by the 8-b ADC (256 levels), BPBS computation results in computational rounding that is different than standard integer computation. However, precise charge-domain operation both in the IMC column and the ADC makes it possible to robustly model the rounding effects within architectural and software abstractions.

FIG. 3B depicts an image of realized heterogeneous microprocessor chip comprising an integration of a programmable heterogeneous architecture as well as software level interfaces. The current work extends the art by developing a heterogeneous IMC architecture driven by application mapping for efficient and scalable execution. As will be described, the BPBS approach is exploited to overcome hardware granularity constraints that arise from the fundamental need for high row parallelism for energy efficiency and throughput in IMC.

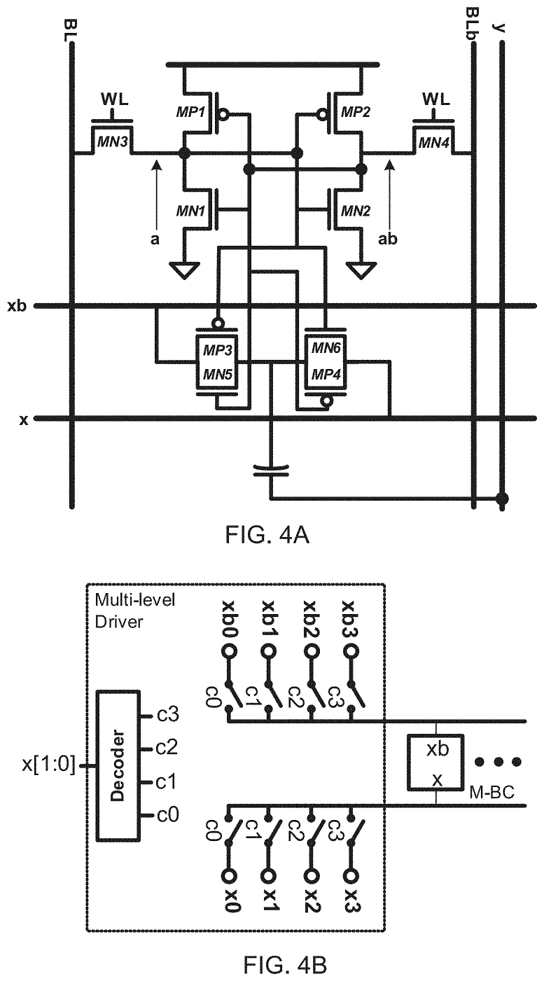

FIG. 4A depicts a circuit diagram of an analog input voltage bit-cell suitable for use in various embodiments. The analog input voltage bit-cell design of FIG. 4A may be used in place of the digital input (digital input voltage level) bit-cell design depicted above with respect to FIG. 2B. The bit-cell design of FIG. 4A is configured to enable input-vector elements to be applied with multiple voltage levels rather than two digital voltage levels (e.g., V_{DD} and GND). In various embodiments, the use of the bit-cell design of FIG. 4A enables a reduction in the number of BPBS cycles, thereby benefitting the throughput and energy accordingly. Further, by providing the multi-level voltages (e.g., x0,x1,x2,x3 and xb0,xb1,xb2,xb3) from dedicated supplies, additional energy reduction is achieved, such as due to the use of lower voltage levels.

The illustrated bit-cell circuit of FIG. 4A is depicted as having a switch-free coupled structure according to an embodiment. It is noted that other variations of this circuit are also possible within the context of the disclosed embodiments. The bit-cell circuit enables implementation of either XNOR or AND operation between data stored W/Wb (within the 6-transistor cross-coupled circuit formed by MN1-3/MP1-2) and data inputted IA/IAb. For example, for a XNOR operation, after resetting, IA/IAb can be driven in a complementary manner, resulting in the bottom plate of the local capacitor being pulled up/down according to IA XNOR W. On the other hand, for an AND operation, after resetting, only IA may be driven (and IAb kept low), resulting in the bottom plate of the local capacitor being pulled up/down according to IA AND W. Advantageously, this structure enables a reduction in total switching energy of the capacitors due to a series pull-up/pull-down charging structure resulting between all of the coupled capacitors, as well as a reduction in the effects of switch charge injection errors due to the elimination of a coupling switch at the output node.

### Multi-Level Driver

FIG. 4B depicts a circuit diagram of a multi-level driver suitable for providing analog input voltages to the analog-input bit cell of FIG. 4A. It is noted that while the multi-level driver 1000 of FIG. 4B is depicted as providing eight levels of output voltage, any number of output voltage levels may actually be used to support processing of any number of bits for the input-vector elements in each cycle. The actual voltage levels of the dedicated supplies can be fixed or selected using off-chip control. As an example, this can be beneficial for configuring XNOR computation in the bit cell, required when the multiple bits of input-vector elements are taken to be +1/−1, vs AND computation, required when the multiple bits of the input-vector elements are taken to be 0/1, as in standard two's compliment format. In this case, XNOR computation requires using x3,x2,x1,x0,xb0,xb1,xb2,xb3 to uniformly cover the input voltage range from V_{DD} to 0 V, while AND computation requires using x3,x2,x1,x0 to uniformly cover the input voltage range from V_{DD} to 0V and setting xb0,xb1,xb2,xb3 to 0 V. The various embodiments may be modified as needed to provide a multi-level driver where dedicated supplies may be configured from off-chip/external control, such as to support number formats for XNOR computation, AND computation, and the like.

It should be noted that the dedicated voltages can be readily provided, since the current from each supply is correspondingly reduced, allowing the power-grid density of each supply to also be correspondingly reduced (thus, requiring no additional power-grid wiring resources). One challenge of some applications may be a need for multi-level repeaters, such as in the case where many IMC columns must be driven (i.e., a number of IMC column to be driven beyond the capabilities of a single driver circuit). In this case, the digital input-vector bits may be routed across the IMC array, in addition to the analog driver/repeater output. Thus, the number of levels should be chosen based on routing resource availability.

In various embodiments, bit cells are depicted wherein a 1-bit input operand is represented by one of two values, binary zero (GND) and binary one (V_{DD}). This operand is multiplied by the bit cell by another 1-b value, which results in the storage of one of these two voltage levels in the sampling capacitor associated with that bit cell. When all the capacitors of a column including that bit cell are connected together to gather the stored values of those capacitors (i.e., the charge stored in each capacitor), the resulting accumulated charge provides a voltage level representing an accumulation of all the multiplication results of each bit-cell in the column of bit cells.

Various embodiments contemplate the use of bit-cells where an n-bit operand is used, and where the voltage level representing the n-bit operand necessarily comprises one of n different voltage levels. For example, a 3-bit operand may be represented by 8 different voltage levels. When that operand is multiplied at a bit cell the resulting charge imparted to the storage capacitor is such that n different voltage levels may be present during the accumulation phase (shorting of the column of capacitors). In this manner, a more accurate and flexible system is provided. The multi-level driver of FIG. 4 is therefore used in various embodiments to provide such accuracy/flexibility. Specifically, in response to an n-bit operand, one of n voltage levels is selected and coupled to the bit-cell for processing. Thus, multi-level input-vector element signaling is provided by a multi-level driver employing dedicated voltage supplies, which are selected by decoding multiple bits of the operand or input-vector element.

### Challenges for Scalable IMC

IMC poses three notable challenges for scalable mapping of NNs, which arise from its fundamental structure and tradeoffs; namely, (1) matrix loading costs, (2) intrinsic coupling between data-storage and compute resources, and (3) large column dimensionality for row parallelism, each of which is discussed below. This discussion is informed by Table I (which illustrates some of the IMC Challenges for Scalable Application Mapping for, illustratively, CNN benchmarks) and algorithm 1 (which illustrates exemplary pseudocode for execution loops in a typical CNN), which provide application context, using common convolutional NN (CNN) benchmarks at 8-b precision (first layer excluded from analysis due to characteristically few input channels).

TABLE I

| | | darknet19 | resnet18 | resnet34 | resnet50 | resnet101 | vgg19 | alexnet |
|---|---|---|---|---|---|---|---|---|
| 8-b Model | (bits) | 166,608,896 | 89,260,032 | 170,065,920 | 187,564,032 | 339,083,264 | 160,137,216 | 29,687,808 |
| Weights | | | | | | | | |
| Feature | (max) | 12544 | 3136 | 3136 | 3136 | 3136 | 50176 | 729 |
| Map Pixel | (min) | 49 | 49 | 49 | 49 | 49 | 196 | 169 |
| Kernel Size | (max) | 3 × 3 × 512 | 3 × 3 × 512 | 3 × 3 × 512 | 3 × 3 × 512 | 3 × 3 × 512 | 3 × 3 × 512 | 3 × 3 × 384 |
| | (min) | 1 × 1 × 128 | 1 × 1 × 64 | 1 × 1 × 64 | 1 × 1 × 64 | 1 × 1 × 64 | 3 × 3 × 64 | 3 × 3 × 256 |

Algorithm 1

| | |
|---|---|
| 1: | for Batch b = 1 to B by b+ = 1 do |
| 2: | for Layer l = 1 to L by l+ = 1 do |
| 3: | for yPix p_{y}^{l} = 1 to P_{y}^{l} by p_{y}^{l}+ = yStride do |
| 4: | for xPix pₓ^{l} = 1 to Pₓ^{l} by pₓ^{l}+ = xStride do |
| 5: | for I-ch. c^{l} = 1 to C^{l} by c^{l}+ = 1 do |
| 6: | for O-ch. k^{l} = 1 to K^{l} by k^{l}+ = 1 do |
| 7: | for yFltr j^{l} = 1 to J^{l} by j^{l}+ = 1 do |
| 8: | for xFltr i^{l} = 1 to I^{l} by i^{l}+ = 1 do |
| 9: | A_{b}^{l}[k][x][y] = A_{b}^{l-1}[c][pₓ + i][p_{y} + |
| | j] × Wₖ^{l}[c][i][j] |

Matrix-loading costs. As described above in with respect to Fundamental Tradeoffs, IMC reduces memory-read and computation costs (energy, delay), but it does not reduce memory write costs. This can substantially degrade the overall gains in full application executions. A common approach in reported demonstrations has been to load and keep matrix data statically in memory. However, this becomes infeasible for applications of practical scale, in terms of both the amount of storage necessary, as illustrated by the large number of model parameters in the first row of Table I, and the replication required to ensure adequate utilization, as described below.

Intrinsic coupling between data-storage and compute resources. By combining memory and computation, WIC is constrained in assigning computation resources together with storage resources. The data involved in practical NNs can be both large (first row of Table I), placing substantial strain on storage resources, but also widely varying in computational requirements. For instance, the MAC operations involving each weight is set by the number of pixels in the output feature map. As illustrated in the second row of Table I, this varies significantly from layer to layer. It can lead to considerable loss of utilization unless mapping strategies equalize the operations.

Large column dimensionality for row parallelism. As described above with respect to Fundamental Tradeoffs, IMC derives its gains from high levels of row parallelism. However, large column dimensionality to enable high row parallelism reduces the granularity for mapping matrix elements. As illustrated in the third row of Table I, the size of CNN filters varies widely both within and across applications. For layers with small filters, forming filter weights into a matrix and mapping to large IMC columns leads to low utilization and degraded gains from row parallelism.

For illustration, two common strategies for mapping CNNs are considered next, showing how the above challenges manifest. CNN's require mapping the nested loops shown in Algorithm 1. Mapping to hardware involves selecting the loop ordering, and scheduling on parallel hardware in space (unrolling, replicating) and time (blocking).

Static mapping to IMC. Much of the current IMC research has considered mapping entire CNNs statically to the hardware (i.e., Loops 2, 6-8), primarily to avoid the comparatively high matrix-loading costs (1st challenge above). As analyzed in Table II for two approaches, this is likely to lead to very low utilization and/or very large hardware requirements. The first approach simply maps each weight to one IMC bit cell, and further assumes that IMC columns have different dimensionality to perfectly fit the varying sized filters across layer (i.e., disregarding utilization loss from 3rd challenge above). This results in low utilization because each weight is allocated an equal amount of hardware, but the number of MAC operations varies widely, set by the number of pixels in the output feature map (2nd challenge above). Alternatively, the second approach performs replication, mapping weights to multiple IMC bit cells, according to the number of operations required. Again, disregarding utilization loss from the 3^{rd} challenge above, high utilization can now be achieved, but with a very large amount of IMC hardware required. While this may be practical for very small NNs, it is infeasible for NNs of practical size.

TABLE II

| | darknet19 | resnet18 | resnet34 | resnet50 | resnet101 | vgg19 | alexnet |
|---|---|---|---|---|---|---|---|
| Utilization | 0.01 | 0.11 | 0.10 | 0.19 | 0.18 | 0.02 | 0.44 |
| (without | | | | | | | |
| replication) | | | | | | | |
| Total IMC | 21,981,102,080 | 276,824,004 | 578,813,952 | 610,271,232 | 1,216,348,160 | 3,170,893,824 | 177,733,632 |
| bits (with | | | | | | | |
| replication) | | | | | | | |

Thus, more elaborate strategies to map the CNN loops must be considered, involving non-static mapping of weights, and thus incurring weight-loading costs (1st challenge above). It should be pointed out that this raises a further technological challenge when using NVM for IMC, as most NVM technologies face limitations on the number of write cycles.

Layer-by-layer Mapping to IMC. A common approach employed in digital accelerators is to map CNNs layer-by-layer (i.e., unrolling Loops 6-8). This provides ways of readily addressing the 2nd challenge above, as the number of operations involving each weight are equalized. However, the high levels of parallelism often employed for high throughput within accelerators, raises the need for replication in order to ensure high utilization. The primary challenge now becomes high weight-loading cost (1st challenge above).

As an example, unrolling Loops 6-8 and replicating filter weights in multiple PEs enables processing input feature maps in parallel. However, the each of the stored weights are now involved in a smaller number of MAC operations, by the replication factor. The total relative cost of weight loading (1st challenge above) is thus elevated compared that of MAC operations. Though often feasible for digital architectures, this is problematic for IMC, due to two reasons: (1) very high hardware density leads to significant weight replication to maintain utilization, thus substantially increasing matrix-loading costs; (2) lower costs of MAC operations would cause matrix-loading costs to dominate, significantly mitigating gains at the full application level.

Generally speaking, layer-by-layer mapping refers to mapping where the next layer is not currently mapped to any CIMU such that data needs to be buffered, whereas layer-unrolled mapping refers to mapping where the next layer is currently mapped to a CIMU such that data proceeds through in a pipeline. Both layer-by-layer mapping and layer-unrolled mapping are supported in various embodiments.

### Scalable Application Mapping for IMC

Various embodiments contemplate an approach to scalable mapping that employs two ideas; namely, (1) unrolling the layer loop (Loop 2), to achieve high utilization of parallel hardware; and (2) exploiting the emergence of two additional loops from BPBS computation. These ideas are described further below.

Layer unrolling. This approach still involves unrolling Loops 6-8. However, instead of replication over parallel hardware, which reduces the number of operations each hardware unit and loaded weight is involved in, parallel hardware is used to map multiple NN layers.

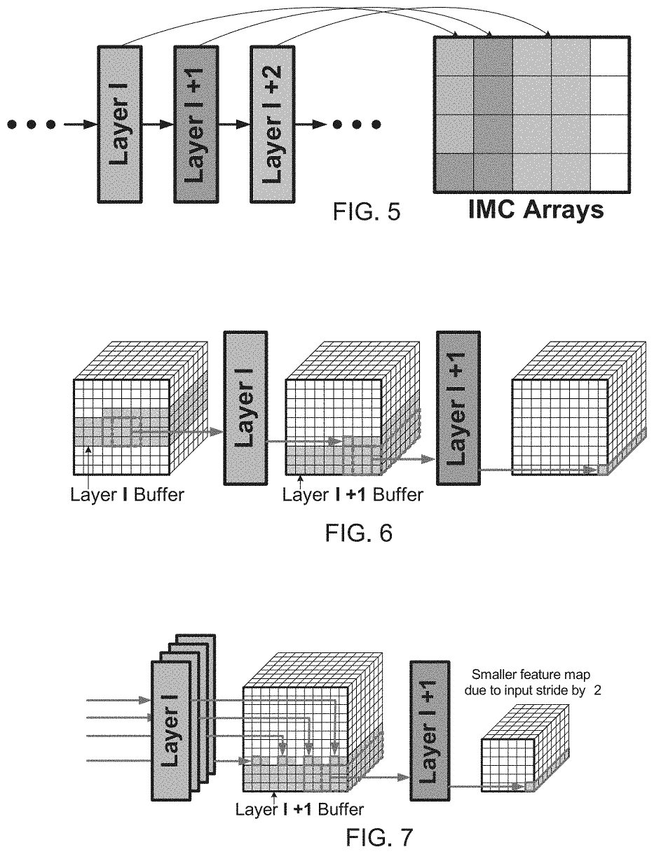

FIG. 5 graphically depicts layer unrolling by mapping multiple NN layers such that a pipeline is effectively formed. As described below, in various embodiments the filters within a NN layer are mapped to one or more physical IMC banks. If more IMC banks are required for a particular layer than can be physically supported, Loop 5 and/or Loop 6 is blocked, and filters of the NN layer are mapped subsequently in time. This enables scalability of both the NN input and output channels that can be supported. On the other hand, if more IMC banks are required for mapping the next layer than can be physically supported, Loop 2 is blocked, and layers are mapped subsequently in time. This leads to pipeline segments of the NN layers, and enables scalability of the NN depth that can be supported. However, such a pipeline of NN layers raises two challenges for latency and throughput.

Regarding latency, a pipeline causes delay in generating the output feature map. Some latency is intrinsically incurred due to the deep nature of NNs. However, in a more conventional layer-by-layer mapping, all of the available hardware is immediately utilized. Unrolling the layer loop effectively defers hardware utilization for later layers. While such pipeline loading is only incurred at startup, the emphasis on small-batch inference for the wide range of latency-sensitive applications, makes it an important concern. Various embodiments mitigate latency using a approach referred to herein as pixel-level pipelining.

FIG. 6 graphically depicts pixel-level pipelining with input buffering of feature-map rows. Specifically, the goal of pixel-level pipelining is to initiate processing of subsequent layers as early as possible. Feature-map pixels represent the smallest granularity data structure being processed through the pipeline. Thus, pixels, consisting of parallel output activations computed from hardware executing a given layer, are immediately provided to hardware executing the next layer. In CNNs, some pipeline latency beyond that of single pixels must be incurred, since i^{l}×j^{l} filter kernels require a corresponding number of pixels to be available for computation. This raises the requirement for local line buffers near IMC, to avoid the high costs of moving inter-layer activations to a global buffer. To ease buffering complexity, the approach of various embodiments to pixel-level pipelining fills the input line buffer by receiving feature map pixels row-by-row, as illustrated in FIG. 6.

Regarding throughput, pipelining requires throughput matching across CNN layers. The required operations vary widely across layers, due to both the number of weights and the number of operations per weight. As previously mentioned, IMC intrinsically couples data-storage and compute resources. This provides hardware allocation addressing operation scaling with the number of weights. However, the operations per weight is determined by the number of pixels in the output feature map, which itself varies widely (second row of Table I).

FIG. 7 graphically depicts replication for throughput matching in pixel-level pipelining, where fewer operations in layer l+1 (e.g., due to larger convolutional striding) requires replication for layer l. As illustrated in FIG. 7, throughput matching thus makes replication necessary within the mapping of each CNN layer, according to the number of output feature-map pixels (layer l has 4× as many output pixels as layer l+1). Otherwise, layers with smaller number of output pixels would incur lost utilization, due to pipeline stalling.

As discussed above, replication reduces the number of operations involving each weight stored in parallel hardware. This is problematic in IMC, where the lower cost of MAC operations requires maintaining a large number of operations per stored weight to amortize matrix-loading costs. However, in practice, the replication required for throughput matching is found to be acceptable for two reasons. First, such replication is not done uniformly for all layers, but rather explicitly according to the number of operations per weight. Thus, hardware used for replication can still substantially amortize the matrix-loading costs. Second, large amounts of replication lead to all of the physical IMC banks being utilized. For subsequent layers, this enforces a new pipeline segment with independent throughput matching and replication requirements. Thus, the amount of replication is self-regulated by the amount of hardware.

Algorithm 2 depicts exemplary pseudocode for execution loops in a CNN using bit-parallel/bit-serial (BPBS) computation according to various embodiments.

Algorithm 2

| | |
|---|---|
| 1: | for Batch b = 1 to B by b+ = 1 do |
| 2: | for Layer l = 1 to L by l+ = 1 do |
| 3: | for yPix p_{y} = 1 to P_{y} by p_{y}+ = yStride do |
| 4: | for xPix pₓ = 1 to Pₓ by pₓ+ = xStride do |
| 5: | for I-ch. c = 1 to C by c+ = 1 do |
| 6: | for O-ch. k = 1 to K by k+ = 1 do |
| 7: | for yFltr j = 1 to J by j+ = 1 do |
| 8: | for xFltr i = 1 to I by i+ = 1 do |
| 9: | for actBit bₐ = 1 to Bₐ by bₐ+ = 1 do |
| 10: | for wtBit b_{w} = 1 to B_{w} by b_{w}+ = 1 do |
| 11: | A_{b}[k][x][y] = (A_{b}[c][pₓ + i][p_{y} + j][bₐ] × |
| | 2^{b}^{ₐ} ) × (Wₖ^{l}[c][i][j][b_{w}] × 2^{b}^{_{w}} ) |

BPBS unrolling. As previously noted, the need for high column dimensionality to maximize gains from IMC results in lost utilization when used to map smaller filters. However, BPBS computation effectively gives rise to two additional loops, as shown in Algorithm 2, corresponding to the input-activation bit being processes and the weight bit being processed. These loops can be unrolled to increase the amount of column hardware used.

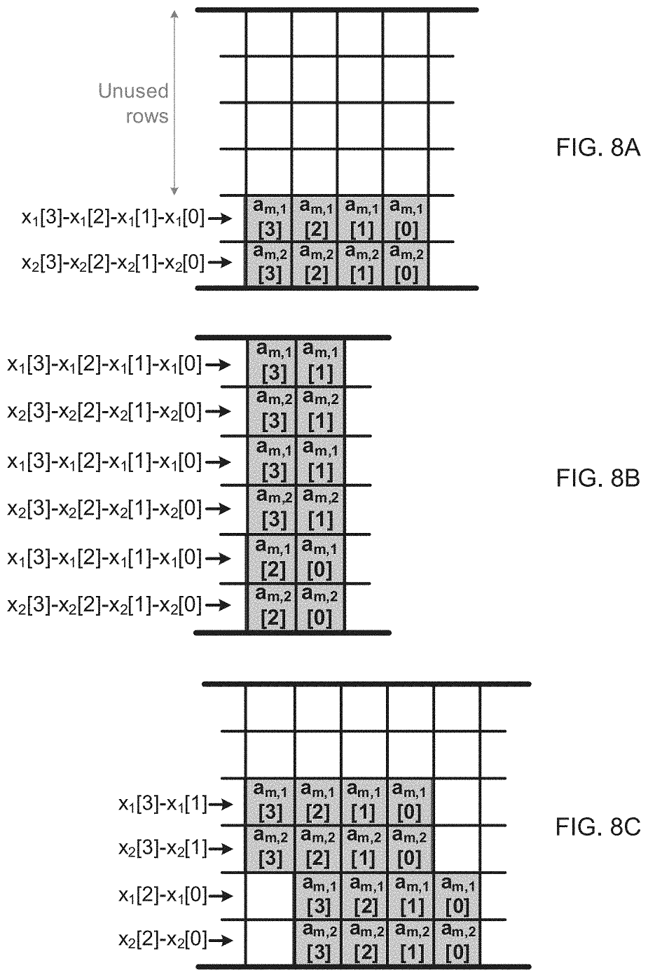

FIG. 8 depicts diagrammatic representations of row underutilization and mechanisms to address row underutilization useful in understanding the various embodiments. Specifically, FIG. 8 depicts the challenge of row utilization, and the results of unrolling BPBS computation loops to increase IMC column utilization

FIG. 8A graphically depicts the challenge of row underutilization, where small filters occupy only ⅓rd of IMC columns as an example. Assuming 4-b weights, the BPBS approach employs four parallel columns for each filter. Two alternate mapping approaches can be employed to increase utilization above 0.33. The first approach is illustrated in FIG. 8b, where two adjacent columns are merged into one. However, because the original columns correspond to different matrix-element bit positions, the bits from the more-significant position must be replicated in the column with corresponding binary weighting, and the serially-provided input-vector elements are simply replicated similarly. This ensures proper capacitive charge shorting during the column accumulation operation.

FIG. 8A graphically depicts the effective utilization of columns. Specifically, column merging has two limitations. First, the replication required to merge bits from more-significant matrix-element positions leads to high physical utilization, but somewhat less effective utilization. For instance, the effective utilization of columns in FIG. 8B is only 0.66, and is further restricted as more columns are merged with corresponding binary-weighted replication. Second, due to the need for binary-weighted replication, the column dimensionality requirements increase exponentially with the number of columns being merged. This limits the cases in which column merging can be applied.

For example, two columns can be merged only if the original utilization is <0.33, three columns can be merged if the original utilization is <0.14, four columns can be merged only if the original utilization is <0.07, etc. The second approach of duplication and shifting is illustrated in FIG. 8C. Specifically, matrix elements are duplicated and shifted, requiring an additional IMC column. In this case, two input-vector bits are provided in parallel, with the more-significant bit provided to the shifted matrix elements. Unlike column merging, duplication and shifting results in high effective utilization, equal to the physical utilization. Further, the column dimensionality requirements do not increase exponentially with the effective utilization, making duplication and shifting applicable in more cases. The primary limitation is that while columns in the center achieve high utilization, columns towards either edge incur reducing utilization, with the first and last columns limited to the original utilization level as indicated in FIG. 8C. Nonetheless, for weight precision of 4-8 bits, significant utilization gains are realized using the various embodiments.

Multi-level input activations. The BPBS scheme causes the energy and throughput of IMC computation to scale with the number of input-vector bits, which are applied serially. A multi-level driver is discussed above with respect to FIG. 4

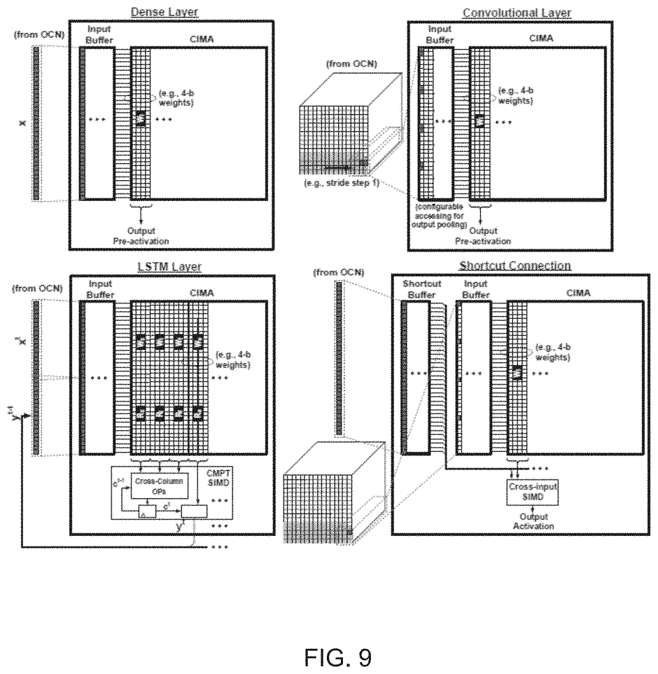

FIG. 9 graphically depicts a sample of the operations enabled by CIMU configurability via a software instruction library. In addition to temporal mapping of NN layers, the architecture provides extensive support for spatial mapping (loop unrolling). Given the high HW density/parallelism of IMC, this provides a range of mapping options for HW utilization, beyond typical replication strategies, which incur excessive state-loading overheads due to state replication across engines. To support spatial mapping of NN layers, various approaches for receiving and sequencing input activations for IMC computation, are shown, enabled by configurability in the Input and Shortcut Buffers, including: (1) high-bandwidth inputting for dense layers; (2) bandwidth-reduced inputting and line buffering for convolutional layers; (3) feed-forward and recurrent inputting, as well as output-element computation, for memory-augmented layers; (4) parallel inputting and buffering of NN and shortcut-path activations, as well as activation summing. A range of other activation receiving/sequencing approaches, and configurability in parameters of the approaches above, are supported.

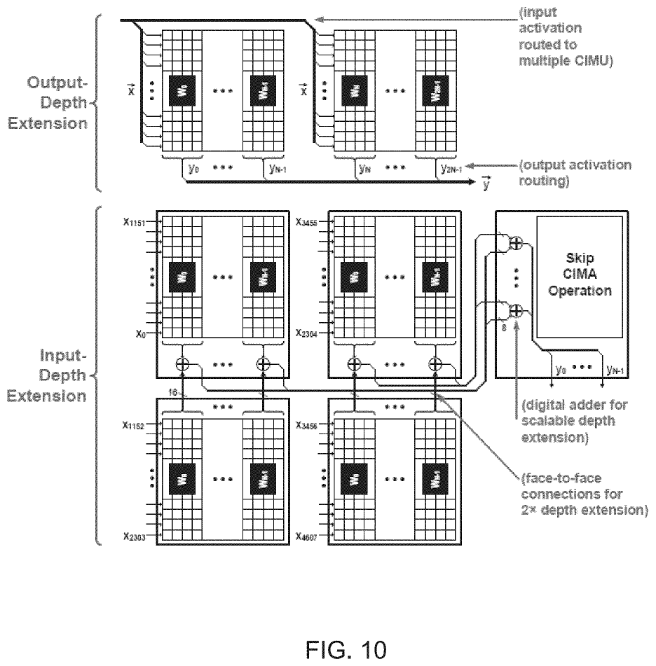

FIG. 10 graphically depicts architectural support for spatial mapping within application layers, such as NN layers, both for mitigating data swapping/movement overheads and for enabling NN model scalability. For instance, output-tensor depth (number of output channels) can be extended by OCN routing of input activations to multiple CIMU. Input-tensor depth (number of input channels) can be extended via short, high-bandwidth face-to-face connections between the outputs of adjacent CIMUs, and further extended by summing the partial pre-activations from two CIMUs by a third CIMU. Efficient scale-up of layer computations in this manner enables a balance in the IMC core dimensions (found by mapping a range of NN benchmarks), where coarse granularity benefits IMC parallelism and energy, and fine granularity benefits efficient computation mapping.

### General Considerations of Modular IMC for Scalability

Both layer unrolling and BPBS unrolling introduce important architectural challenges. With layer unrolling, the primary challenge is that the diverse dataflow and computations between layers in NN applications must now be supported. This necessitates architectural configurability that can generalize to current and future NN designs. In contrast, within one NN layer MVM operations dominate, and a computation engine benefits from the relatively fixed dataflow involved (though, various optimizations have gained interest, to exploit attributes such as sparsity, etc.). Examples of dataflow and computation configurability required between layers are discussed below.

With BPBS unrolling, in particular duplication and shifting affects the bit-wise sequencing of operations on input activations, raising additional complexity for throughput matching (column merging, adheres to bit-wise computation of input activations, preserving sequencing for pixel-level pipelining). More generally, if varying levels of input-activation quantization are employed across layers, thus requiring different numbers of IMC cycles, this must also be considered within the replication approach discussed above for throughput matching in the pixel-level pipeline.

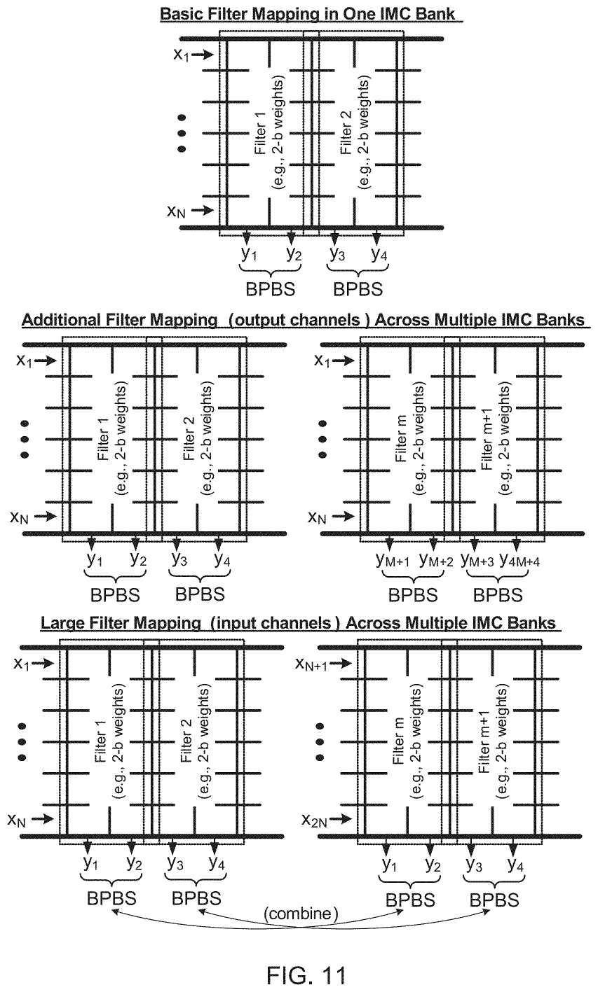

FIG. 11 graphically depicts a method of mapping NN filters to IMC banks, with each bank having dimensionality of N rows and M columns, by loading filter weights in memory as matrix elements and applying input-activations as input-vector elements, to compute output pre-activations as output-vector elements. Specifically, FIG. 11 depicts loading filter weights in memory as matrix elements to IMC banks, and applying input-activations as input-vector elements to compute output pre-activations as output-vector elements. Each bank is depicted as having a dimensionality of N rows and M columns (i.e., processing input vectors of dimensionality N and providing output vectors of dimensionality M).

The IMC implements MVM of the following form: \vec{y}=A×\vec{x}. Each NN layer filter, corresponding to an output channel, is mapped to a set of IMC columns, as required for multi-bit weights. Sets of columns are correspondingly combined via BPBS computation. In this manner, all filter dimensions are mapped to the set of columns, as far as the column dimensionality can support (i.e., unrolling Loops 5, 7, 8). Filters with more output channels than supported by the M IMC columns require additional IMC banks (all fed the same input-vector elements). Similarly, filters of size larger than the N IMC rows require additional IMC banks (each fed with the corresponding input-vector elements).

This corresponds to a weight-stationary mapping. Alternate mappings are also possible, such as input stationary, where input activations are stored in the IMC banks, filters weights are applied as input vectors \vec{x}, and pixels of the corresponding output channel are provided as output vectors \vec{y}. Generally, amortizing the matrix-loading costs favors one approach or the other for different NN layers, due to different number of output feature-map pixels and output channels. However, unrolling the layer loop and employing pixel-level pipelining requires using one approach, to avoid excessive buffering complexity.

### Architectural Supports

Following from the basic approach of mapping NN layers to IMC arrays, various microarchitectural supports around an IMC bank may be provided in accordance with various embodiments.

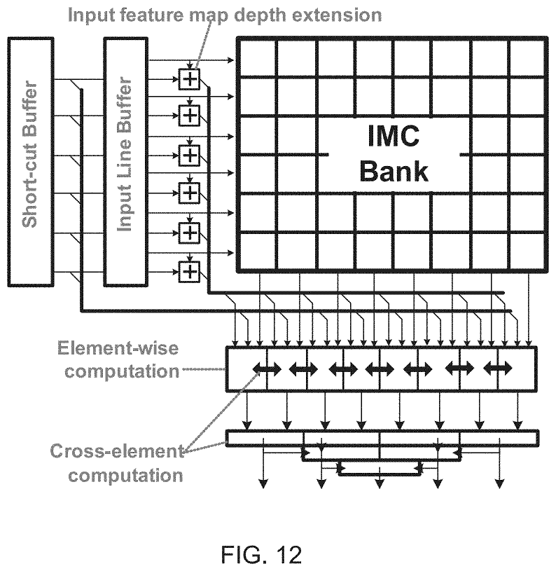

FIG. 12 depicts a block diagram illustrating exemplary architectural support elements associated with IMC banks for layer and BPBS unrolling.

Input line buffering for convolutions. In pixel-level pipelining, output activations for a pixel are generated by one IMC module and transmitted to the next. Further, in the BPBS approach, each bit of the incoming activations is processed at a time. However, convolutions involve computation on multiple pixels at once. This requires configurable buffering at the IMC input, with support for different sized stride steps. Though there are various ways of doing this, the approach in FIG. 12 buffers a number of rows of the input feature map corresponding to the height of the convolutional kernel (as illustrated in FIG. 6). The row width supported by the buffer requires processing input feature maps in vertical segments (e.g., by performing blocking on Loop 4). The kernel height/width supported by the buffer is a key architectural design parameter, but which can take advantage of the trend towards 3×3 primary kernels for constructing larger kernels. With such buffering, in-coming pixel data can be provided to IMC one bit at a time, processed one bit at a time, and transmitted one bit at a time (following output BPBS computation).

The input line buffer can also support taking input pixels from different IMC modules, by having additional input ports from the on-chip network. This enables throughput matching, as required in pixel-level pipelining, by allowing allocation of multiple inputting IMC modules to equalize the number of operations performed by each IMC module within the pipeline. For instance, this may be required if an IMC module is used to map a CNN layer having larger stride step than the preceding CNN layer, or if the preceding CNN layer is followed by a pooling operation. The kernel height/width determines the number of input ports that must be supported, since, in general, stride steps larger than or equal to the kernel height/width result in no convolutional reuse of data, requiring all new pixels for each IMC operation.

It is noted that the inventors contemplate various techniques by which in-coming (received) pixels may be suitably buffered. The approach depicted in FIG. 12 allocates the different input ports to different vertical segments of each row, in the manner shown in FIG. 7.

Near-memory element-wise computations. In order to directly feed data from IMC hardware executing one NN layer to IMC hardware executing the next NN layer, integrated near-memory computation (NMC) is required for operations on individual elements, such as activation functions, batch normalization, scaling, offsetting, etc., as well as operations on small groups of elements, such as pooling, etc. Generally, such operations require a higher level of programmability and involve a smaller amount of input data than MVMs.

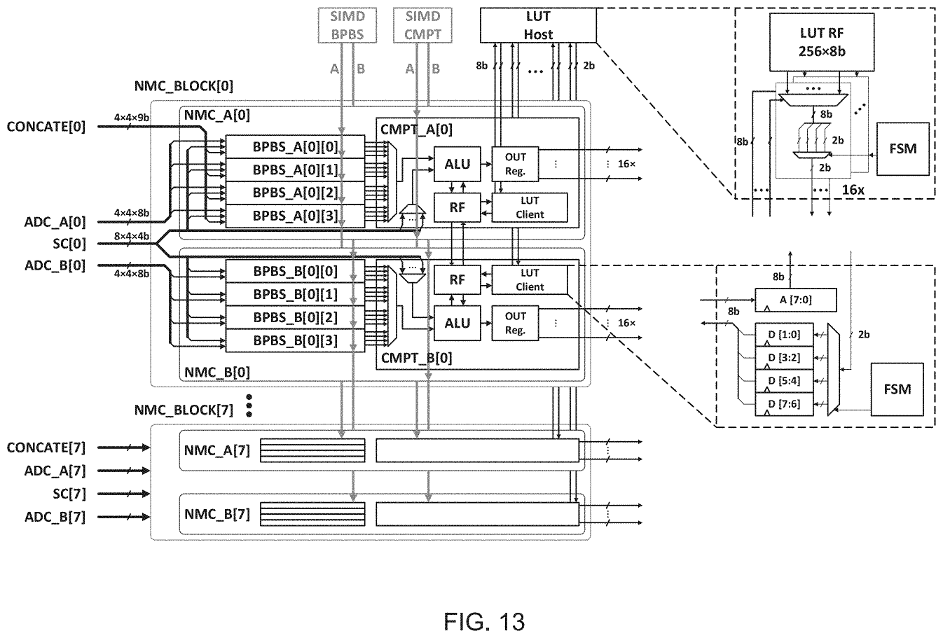

FIG. 13 depicts a block diagram illustrating an exemplary near-memory computation SIMD engine. Specifically, FIG. 13 depicts a programmable single-instruction multiple-data (SIMD) digital engine that is integrated at the IMC output (i.e., following the ADC). The example implementation shown has two SIMD controllers, one for parallel control of BPB S near-memory computations and one for parallel control of other arithmetic near-memory computations. Generally, the SIMD controllers can be combined and/or other such controllers can be included. The NMC shown is grouped into eight blocks, each providing eight channels of computation (A/B, and 0-3) in parallel for the IMC columns and for different ways of configuring the columns. Each channel includes local arithmetic logic unit (ALU) and register file (RF), and is multiplexed across four columns, to address throughput and layout pitch matching to the IMC computations. In general, other architectures can be employed. Additionally, a lookup-table (LUT)-based implementation for non-linear functions is shown. This can be used for arbitrary activation functions. Here, a single LUT is shared across all parallel computation blocks and bits of the LUT entries are broadcasted serially across the computation blocks. Each computation block then selects the desired entry, receiving bits serially over a number of cycles corresponding to the bit precision of entries. This is controlled via LUT client (FSM) in each parallel computation block, avoiding the area cost of having a LUT for every computation block, at the cost of broadcasting wires.

Near-memory cross-element computations. In general, operations are not only required on individual output elements from MVM operations, but also across output elements. For instance, this is the case in Long Short Term Memories (LSTMs), Gated Recurring Units (GRUs), transformer networks, etc. Thus, the near-memory SIMD engine in FIG. 10 supports subsequent digital operations between adjacent IMC columns as well as reduction operations (adder, multiplier tree) across all columns.

As an example, for mapping LSTMs, GRUs, etc. where output elements from different MVM operations are combined via element-wise computations, the matrices can be mapped to different interleaved IMC columns, so that the corresponding output-vector elements are available in adjacent rows for near-memory cross-element computations.

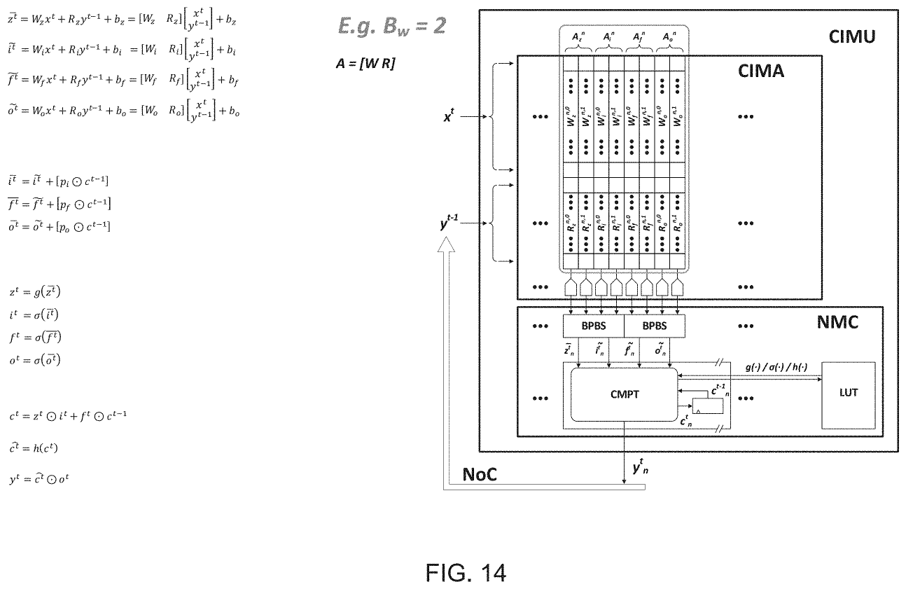

FIG. 14 depicts a diagrammatic representation of an exemplary LSTM layer mapping function exploiting cross-element near-memory computation. Specifically, as illustrated in FIG. 14, for a typical LSTM layer mapping to the CIMU for the example of 2-b weights (B_{w}=2). GRUs follow similar mapping. To generate each output y^{t}, four MVM operations are performed, yielding the intermediate outputs z̅^{t}, [symbol] , [symbol] , [symbol] . Each of the MVMs involves two concatenated matrices (W,R) and vectors (x^{t},y^{t-1}), where the second vector provides recursion for memory augmentation. The intermediate outputs are transformed through an activation function (g,σ), and then combined to derive a local output (c^{t}/ [symbol] ) and the final output y^{t}. The activation functions and computations for combining the intermediate MVM outputs are performed in the near-memory-computing hardware, as shown (taking advantage of the LUT-based approach to activation functions for g,σ,h, and local scratch-pad memory for storing c^{t}/ [symbol] ). To enable efficient combining, the different W,R matrices are interleaved in the CIMA, as shown.

In various embodiments, each CIMU is associated with a respective near-memory, programmable single-instruction multiple-data (SIMD) digital engine, which may be included within the CIMU, outside of the CIMU, and/or a separate element in the array including CIMUs. The SIMD digital engine is suitable for use in combining or temporally aligning input buffer data, shortcut buffer data, and/or output feature vector data for inclusion within a feature vector map. The various embodiments enable computation across/between parallelized computation paths of the SIMD engine(s).

Short-cut buffering and merging. In pixel-level pipelining, spanning across NN layers requires special buffering for shortcut paths, to match the pipeline latency to that of NN paths. In FIG. 12 such buffering for the short-cut path is incorporated alongside the IMC input line buffering for the computed NN path, such that the dataflow and delay of the two paths are matched. With the possibility of multiple overlapping shot-cut paths (e.g., as in U-Nets), the number of such buffers to include is an important architectural parameter. However, buffers available from any IMC bank can be used for this, affording flexibility in mapping such overlapping short-cut paths. Eventual summation of the short-cut and NN computed path is supported by feeding short-cut buffer outputs to the near-memory SIMD, as shown. The short-cut buffer can support input ports in a similar manner to the input line buffer. However, typically in a CNN, the layers a short-cut connection passes over maintain a fixed number of output pixels, to allow eventual pixel-wise summation; this leads to a fixed number of operations across the layers, typically leading to an IMC module being fed by one IMC module. Exceptions to this include U-Nets, making additional input ports in the short-cut buffer potentially beneficial.

Input feature map depth extension. The number of IMC rows limits the input feature map depth that can be processed, necessitating depth extension through the use of multiple IMC banks. With multiple IMC banks used to process deep input channels in segments, FIG. 10 includes hardware for adding the segments together in a subsequent IMC bank. Preceding segment data is provided in parallel across the output channels to the local input and short-cut buffers. The parallel segment data is then added together via a custom adder between the two buffer outputs. Arbitrary depth extension can be performed by cascading IMC banks to perform such adding.

The adder output feeds the near-memory SIMD, enabling further element-wise and cross-element computations (e.g., activation functions).

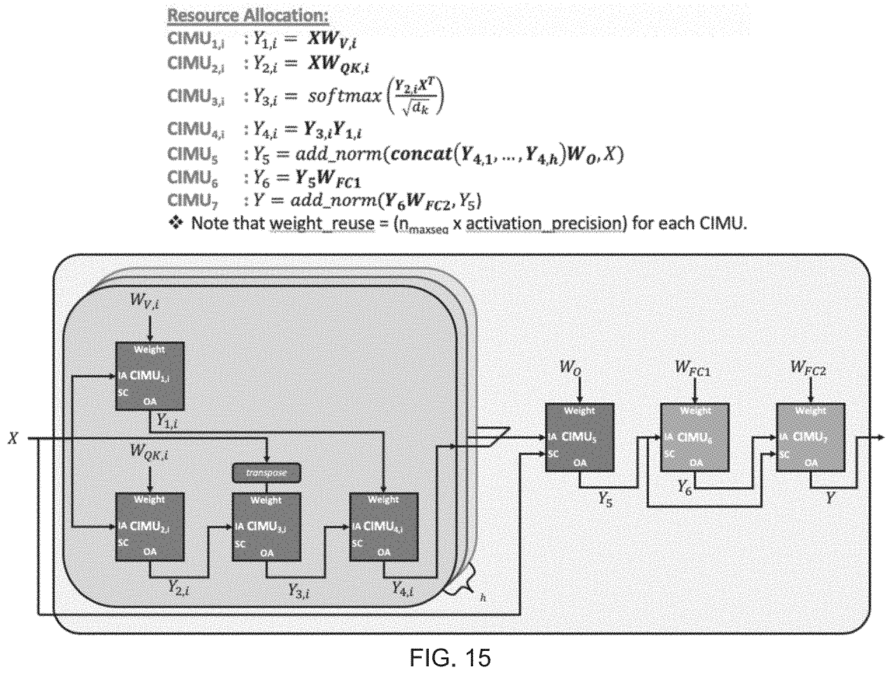

On-chip network interfaces for weight loading. In addition to input interfaces for receiving input-vector data from an on-chip network (i.e., for MVM computation), interfaces may also be included for receiving weight data from the on-chip network (i.e., for storing matrix element). This enables matrices generated from MVM computations to be employed for IMC-based MVM operations, which is beneficial in various applications such as, illustratively, mapping transformer networks. Specifically, FIG. 15 graphically illustrates mapping of a Bidirectional Encoder Representations from Transformers (BERT) layer using generated data as a loaded matrix. In this example, both the input-vectors X and the generated matrix Y_{i,1} are loaded into IMC modules through the weight-loading interface. The on-chip network may be implemented as a single on-chip network, as a plurality of on-chip network portions, or as a combination of on-chip and off-chip network portions.

### Scalable IMC Architecture

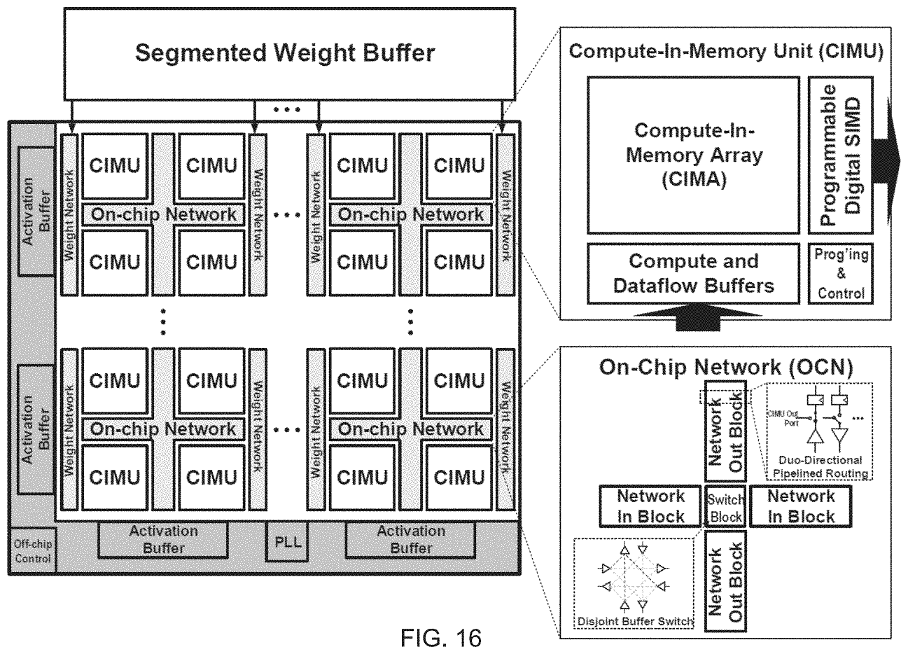

FIG. 16 depicts a high-level block diagram of a scalable NN accelerator architecture based on IMC in accordance with some embodiments. Specifically, FIG. 16 depicts a scalable NN accelerator based on IMC wherein integrated microarchitectural supports for application mapping around an IMC bank forms a module that enables architectural scale-up by tiling and interconnection.

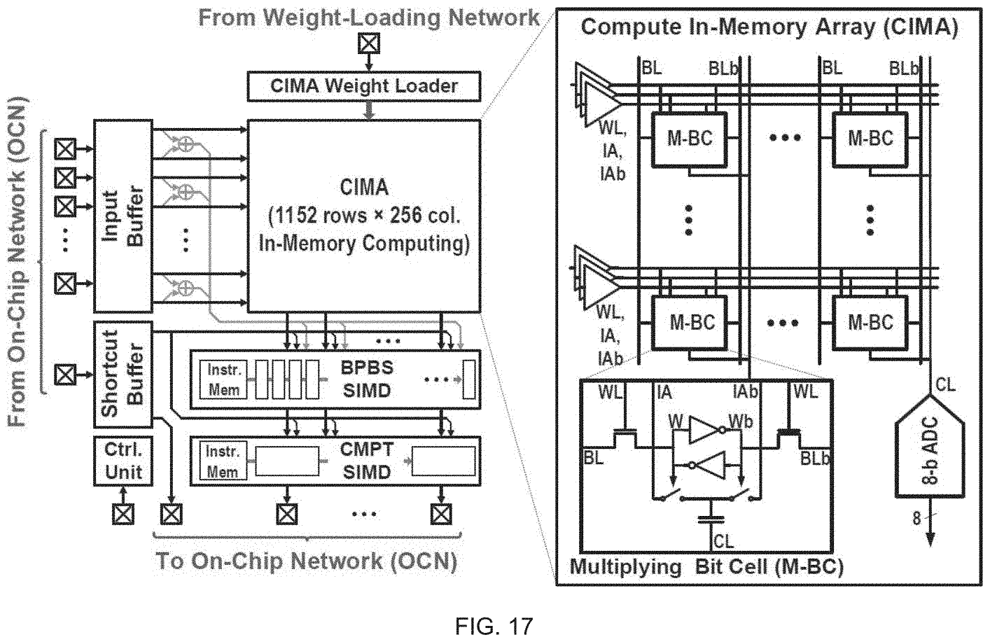

FIG. 17 depicts a high-level block diagram of a CIMU microarchitecture with 1152×256 IMC bank suitable for use in the architecture of FIG. 16. That is, while the overall architecture is illustrated in FIG. 16, a module with integrated IMC bank and microarchitectural supports referred to as a Compute-In-Memory Unit (CIMU) suitable for use in that architecture is depicted in FIG. 17. The inventors have determined that benchmark throughput, latency, and energy scale with the number of tiles (throughput/latency should scales proportionally, energy remains substantially constant).

As depicted in FIG. 16, the array-based architecture comprises: (1) a 4×4 array of Compute In-Memory-Unit (CIMU) cores; (2) an On-Chip Network (OCN) between cores; (3) off-chip interfaces and control circuits; and (4) additional weight buffers with a dedicated weight-loading network to the CIMUs.

As depicted in FIG. 17, each of the CIMUs may include: (1) an IMC engine for MVMs, denoted as a Compute-In-Memory Array (CIMA); (2) an NMC digital SIMD with custom instruction set, for flexible element-wise operations; and (3) buffering and control circuitry for enabling a wide range of NN dataflows. Each CIMU core provides a high-level of configurability and may be abstracted into a software library of instructions for interfacing with a compiler (for allocating/mapping an application, NN and the like to the architecture), and where instructions can thus also be added prospectively. That is, the library includes single/fused instructions such as element mult/add, h(•) activation, (N-step convolutional stride+MVM+batch norm. +h(•) activation+max. pool), (dense+MVM) and the like.

The OCN consists of routing channels within Network In/Out Blocks, and a Switch Block, which provides flexibility via a disjoint architecture. The OCN works with configurable CIMU input/output ports to optimize data structuring to/from the IMC engine, to maximize data locality across MVM dimensionalities and tensor depth/pixel indices. The OCN routing channels may include bidirectional wire pairs, so as to ease repeater/pipeline-FF insertion, while providing sufficient density.

The IMC architecture may be used to implement a neural network (NN) accelerator, wherein a plurality of compute in memory units (CIMUs) are arrayed and interconnected using a very flexible on-chip network wherein the outputs of one CIMU may be connected to or flow to the inputs of another CIMU or to multiple other CIMUs, the outputs of many CIMUs may be connected to the inputs of one CIMU, the outputs of one CIMU may be connected to the outputs of another CIMU and so on. The on-chip network may be implemented as a single on-chip network, as a plurality of on-chip network portions, or as a combination of on-chip and off-chip network portions.

Referring to FIG. 17, at a CIMU data is received from the OCN via one of two buffers: (1) the Input Buffer, which configurably provides data to the CIMA; and (2) the Shortcut Buffer, which bypasses the CIMA, providing data directly to the NMC digital SIMD for element-wise computations on separate and/or convergent NN activation paths. The central block is the CIMA, which consists of a mixed-signal N(row)×M(column) (e.g., 1152(row)×256(col.)) IMC macro for multibit-element MVMs. In various embodiments, the CIMA employs a variant of fully row/column-parallel computation, based on metal-fringing capacitors. Each multiplying bit cell (M-BC) drives its capacitor with a 1-b digital multiplication (XNOR/AND), involving inputted activation data (IA/IAb) and stored weight data (W/Wb). This causes charge redistribution across M-BC capacitors in a column to give an inner product between binary vectors on the compute line (CL). This yields low compute noise (nonlinearity, variability), since multiplication is digital and accumulation involves only capacitors, defined by high lithographic precision. An 8-b SAR ADC digitizes the CL and enables extension to multibit activations/weights, via bit-parallel/bit-serial (BP/BS) computation, where weight bits are mapped to parallel columns and activation bits are inputted serially. Each column thus performs binary-vector inner products, with multibit-vector inner product simply achieved by digital bit shifting (for proper binary weighting) and summing across the column-ADC outputs. Digital BP/BS operations occur in the dedicated NMC BPBS SIMD module, which may be optimized for 1-8 b weights/activations, and further programmable element-wise operations (e.g., arbitrary activations functions) occur in the NMC CMPT SIMD module.

In the overall architecture, CIMUs are each surrounded by an on-chip network for moving activations between CIMUs (activation network) as well as moving weights from embedded L2 memory to CIMUs (weight-loading interface). This has similarities with architectures used for coarse-grained reconfigurable arrays (CGRAs), but with cores providing high-efficiency MVM and element-wise computations targeted for NN acceleration.

Various options exist for implementing the on-chip network. The approach in FIGS. 16-17 enables routing segments along a CIMU to take outputs from that CIMU and/or to provide inputs to that CIMU. In this manner data originating from any CIMU can be routed to any CIMU, and any number of CIMU. The implementation employed for described herein.

Various embodiment contemplate an integrated in-memory computing (IMC) architecture configurable to support scalable execution and dataflow of an application mapped thereto, comprising a plurality of configurable Compute-In-Memory Units (CIMUs) forming an array of CIMUs; and a configurable on-chip network for communicating input operands from an input buffer to the CIMUs, for communicating input operands between CIMUs, for communicating computed data between CIMUs, and for communicating computed data from CIMUs to an output buffer.

Each CIMU is associated with an input buffer for receiving computational data from the on-chip network and composing the received computational data into an input vector for matrix vector multiplication (MVM) processing by the CIMU to generate thereby computed data comprising an output vector.

Each CIMU is associated with a shortcut buffer, for receiving computational data from the on-chip network, imparting a temporal delay to the received computational data, and forwarding delayed computation data toward a next CIMU or an output in accordance with a dataflow map such that dataflow alignment across multiple CIMUs is maintained. At least some of the input buffers may be configured to impart a temporal delay to computational data received from the on-chip network or from a shortcut buffer. The dataflow map may support pixel-level pipelining to provide pipeline latency matching.

The temporal delay imparted by a shortcut or input buffers comprises at least one of an absolute temporal delay, a predetermined temporal delay, a temporal delay determined with respect to a size of input computational data, a temporal delay determined with respect to an expected computational time of the CIMU, a control signal received from a dataflow controller, a control signal received from another CIMU, and a control signal generated by the CIMU in response to the occurrence of an event within the CIMU.

In some embodiments, at least one of the input buffer and shortcut buffers of each of the plurality of CIMUs in the array of CIMUs is configured in accordance with a dataflow map supporting pixel-level pipelining to provide pipeline latency matching.

The array of CIMUs may also include parallelized computation hardware configured for processing input data received from at least one of respective input and shortcut buffers.

A least a subset of the CIMUs may be associated with on-chip network portions including operand loading network portions configured in accordance with a dataflow of an application mapped onto the IMC. The application mapped onto the IMC comprises a neural network (NN) mapped onto the IMC such that parallel output computed data of configured CIMUs executing at a given layer are provided to configured CIMUs executing at a next layer, said parallel output computed data forming respective NN feature-map pixels.

The input buffer may be configured for transferring input NN feature-map data to parallelized computation hardware within the CIMU in accordance with a selected stride step. The NN may comprise a convolution neural network (CNN), and the input buffer is used to buffer a number of rows of an input feature map corresponding to a size or height of the CNN kernel.

Each CIMU may include an in-memory computing (IMC) bank configured to perform matrix vector multiplication (MVM) in accordance with a bit-parallel, bit-serial (BPB S) computing process in which single bit computations are performed using an iterative barrel shifting with column weighting process, followed by a results accumulation process.

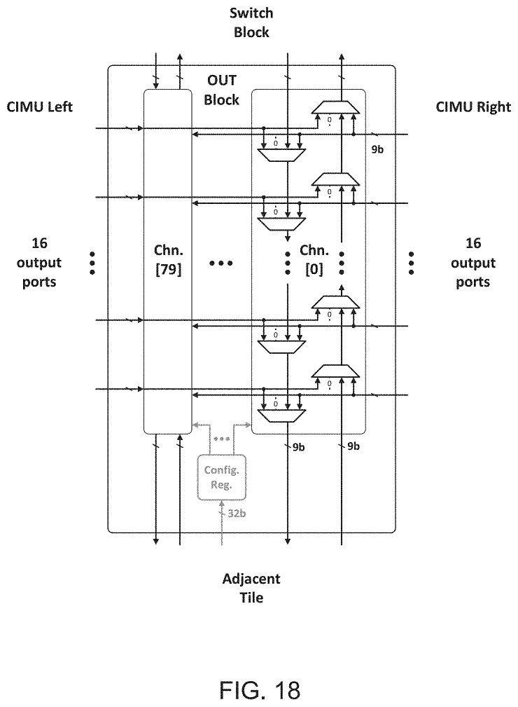

FIG. 18 depicts a high-level block diagram of a segment for taking inputs from a CIMU by employing multiplexors to select whether data on a number of parallel routing channels is taken from the adjacent CIMU or provided from a previous network segment.

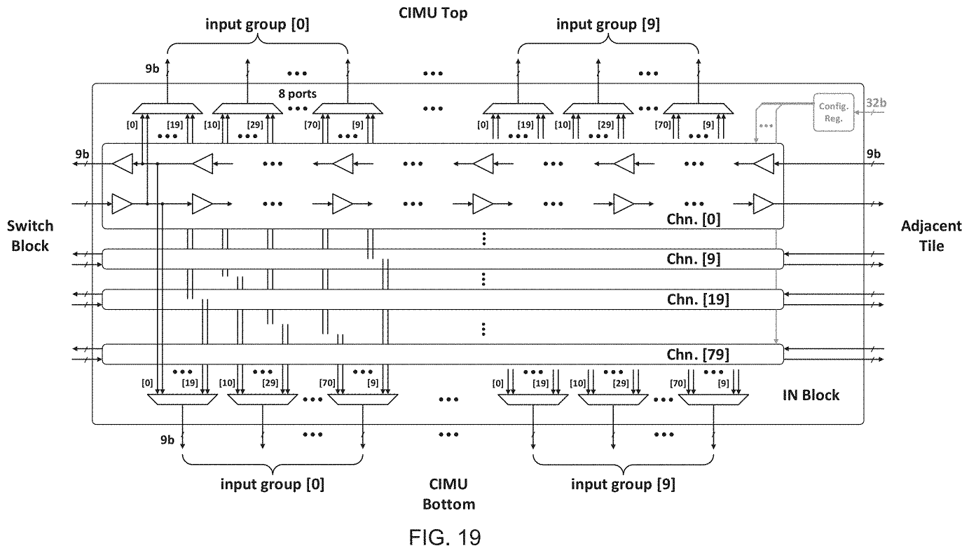

FIG. 19 depicts a high-level block diagram of a segment for providing outputs to a CIMU by employing multiplexors to select whether data from a number of parallel routing channels is provided to an adjacent CIMU.

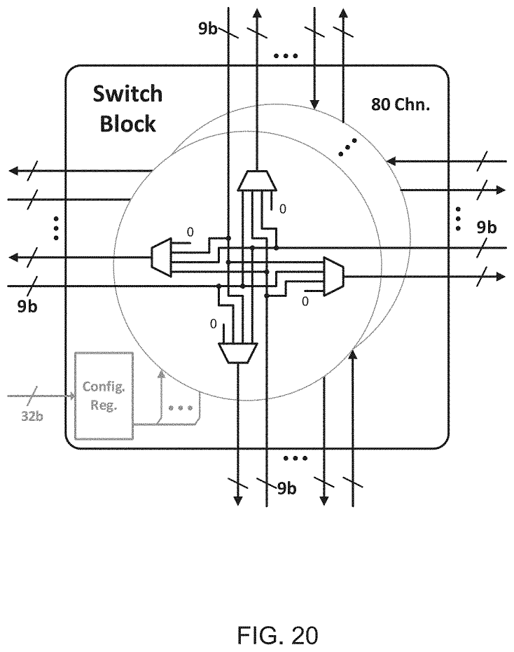

FIG. 20 depicts a high-level block diagram of an exemplary switch block employing multiplexors (and, optionally, flip-flops for pipelining) for selecting which inputs are routed to which outputs. In this way, the number of parallel routing channels to provide is an architectural parameter, which can be selected to ensure full routability (between all points) or high-probability of routability across a desired class of NNs.

In various embodiments, an L2 memory is located along the top and bottom, and partitioned into separate blocks for each CIMU, to reduce accessing costs and networking complexity. The amount of embedded L2 is an architectural parameter selected as appropriate for the application; for example, it may be optimized for the number of NN model parameters typical in the application(s) of interest. However, partitioning into separate blocks for each CIMU requires additional buffering due to replication within pipeline segments. Based on the benchmarks used for this work, 35 MB of total L2 is employed. Other configurations or greater or lesser size are appropriate as per the application.

Each CIMU comprises a IMC bank, near-memory-computing engine, and data buffers, as described above. The IMC bank is selected to be a 1152×256 array, where 1152 is chosen to optimize mapping of 3×3 filters with depth up to 128. The IMC bank dimensionality is selected to balance energy- and area-overhead amortization of peripheral circuitry with computational-rounding considerations.

### Discussion of Several Embodiments

The various embodiments described herein provide an array-based architecture (the array may be 1-, 2-, 3- . . . n-dimensional as needed/desired) formed using a plurality of CIMUs and operationally enhanced via the use of some or all of various configurable/programmable modules directed to flowing data between CIMUs, arranging data to be processed by CIMUs in an efficient manner, delaying data to be processed by CIMUs (or bypass particular CIMUs) to maintain time alignment of a mapped NN (or other application) and so on. Advantageously, the various embodiments enable a scalability by the n-dimensional CIMU array communicating via the network such that different sizes/complexities of NNs, CNNs, and/or other problem spaces where matrix multiplication is an important solutions component may benefit from the various embodiments.

Generally speaking, the CIMUs comprise various structural elements including a computation-in-memory array (CIMA) of bit-cells configured via, illustratively, various configuration registers to provide thereby programmable in-memory computational functions such as matrix-vector multiplications and the like. In particular, a typical CIMU is tasked with multiplying an input matrix X by an input vector A to produce an output matrix Y. The CIMU is depicted as including a computation-in-memory array (CIMA) 310, an Input-Activation Vector Reshaping Buffer (IA BUFF) 320, a sparsity/AND-logic controller 330, a memory read/write interface 340, row decoder/WL drivers 350, a plurality of A/D converters 360 and a near-memory-computing multiply-shift-accumulate data path (NMD) 370.

The CIMUs depicted herein, however implemented, are each surrounded by an on-chip network for moving activations between CIMUs (on-chip network such as an activation network in the case of a NN implementation) as well as moving weights from embedded L2 memory to CIMUs (e.g., weight-loading interfaces) as noted above with respect to Architectural Tradeoffs.

As described above, the activation network comprises a configurable/programmable network for transmitting computation input and output data from, to, and between CIMUs such that in various embodiments the activation network may be construed as an I/O data transfer network, inter-CIMU data transfer network and so on. As such, these terms are used somewhat interchangeably to encompass a configurable/programmable network directed to data transfer to/from CIMUs.

As described above, the weight-loading interface or network comprises a configurable/programmable network for loading operands inside the CIMUs, and may also be denoted as an operand loading network. As such, these terms are used somewhat interchangeably to encompass a configurable/programmable interface or network directed to loading operands such as weighting factors and the like into CIMUs.

As described above, the shortcut buffer is depicted as being associated with a CIMU such as within a CIMU or external to the CIMU. The shortcut buffer may also be used as an array element, depending upon the application being mapped thereto such as a NN, CNN and the like.

As described above, the near-memory, programmable single-instruction multiple-data (SIMD) digital engine (or near-memory buffer or accelerator) is depicted as being associated with a CIMU such as within a CIMU or external to the CIMU. The near-memory, programmable single-instruction multiple-data (SIMD) digital engine (or near-memory buffer or accelerator) buffer may also be used as an array element, depending upon the application being mapped thereto such as a NN, CNN and the like.

It is also noted that in some embodiments the above-described input buffer may also provide data to the CIMA within the CIMU in a configurable manner, such as to provide configurable shifting corresponding to striding in a convolution NN and the like. In order to implement non-linear computations, a lookup table for mapping inputs to outputs in accordance with various non-linear functions may be provided individually to SIMD digital engines of each CIMU, or shared across multiple SIMD digital engines of the CIMUs (e.g., a parallel lookup table implementation of non-linear functions). In this manner, are broadcast from locations of the lookup table across the SIMD digital engines such that each SIMD digital engine may selectively process the specific bit(s) appropriate for that SIMD digital engine.

### Architecture Evaluation—Physical Design

Evaluation of the IMC-based NN accelerator is pursued, compared to a conventional spatial accelerator comprised of digital PEs. Though bit-precision scalability is possible in both designs, fixed-point 8-b computations are assumed. The CIMUs, digital PEs, on-chip-network blocks, and embedded L2 arrays are implemented in a 16 nm CMOS technology through to physical design.

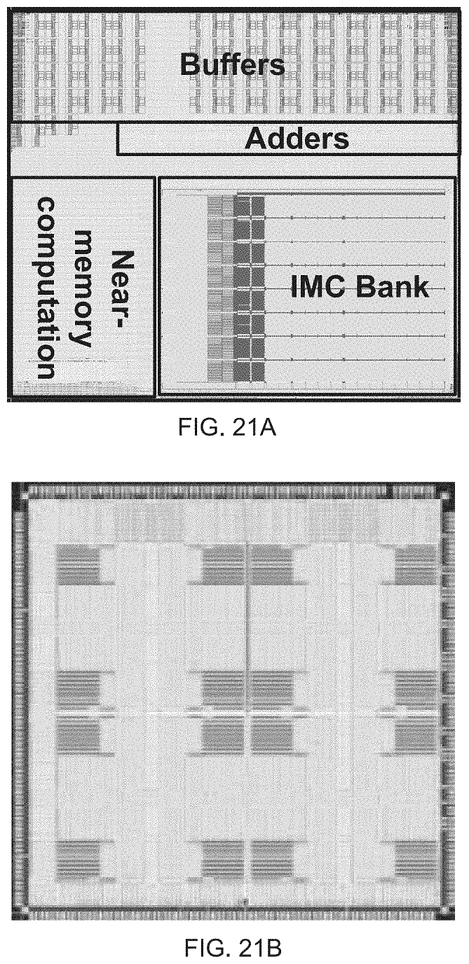

FIG. 21A depicts a layout view of a CIMU architecture according to an embodiment implemented in a 16 nm CMOS technology. FIG. 21B depicts a layout view of a full chip consisting of a 4×4 tiling of CIMUs such as provided in FIG. 21A. The mixed-signal nature of the architecture requires both full-custom transistor-level design, as well as standard-cell-based RTL design (followed by synthesis and APR). For both designs, functional verification is performed at the RTL level. This requires employing a behavioral model of the IMC bank, which itself is verified via Spectre (SPICE-equivalent) simulations.

### Architecture Evaluation—Energy and Speed Modeling

Physical design of the IMC-based and digital architectures enables robust energy and speed modeling, based on post-layout extraction of parasitic capacitances. Speed is parameterized as the achievable clock-cycle frequencies F_{CIMU} and F_{PE} for the IMC-based and digital architectures, respectively (from both STA and Spectre simulations). Energy is parameterized as follows:
Input buffers (E_{Buff}). This is energy in a CIMU required for writing and reading input activations to and from the input and short-cut buffers.
IMC (E_{IMC}). This is energy in a CIMU required for MVM computation via the IMC bank (using 8-b BPBS computation).
Near-memory-computing (E_{NMC}). This is the energy in a CIMU required for near-memory computation of all IMC column outputs.
On-chip network (E_{OCN}). This is the energy in the IMC-based architecture for moving activation data between CIMUs.
Processing engine (E_{PE}). This is the energy in a digital PE for an 8-b MAC operation and output-data movement to adjacent PE.
L2 read (E_{L2}). This is the energy in both IMC-based and digital architectures for reading weight data from L2 memory.
Weight-loading network (E_{WLN}). This is the energy in both IMC-based and digital architectures for moving weight data from L2 memory to CIMUs and PEs, respectively.
CIMU weight loading (E_{WL,CIMU}). This is the energy in a CIMU for writing weight data.
PE weight loading (E_{WL,PE}). This is the energy in a digital PE for writing weight data.

### Architecture Evaluation—Neural-network Mapping and Execution

For comparison of the IMC-based and digital architectures, different physical chip areas are considered, in order to evaluate the impact of architectural scale-up. The areas correspond to 4×4, 8×8, and 16×16 IMC banks. For benchmarking, a set of common CNNs are employed, to evaluate the metrics of energy efficiency, throughput, and latency, with both a small batch size (1) and large batch size (128).

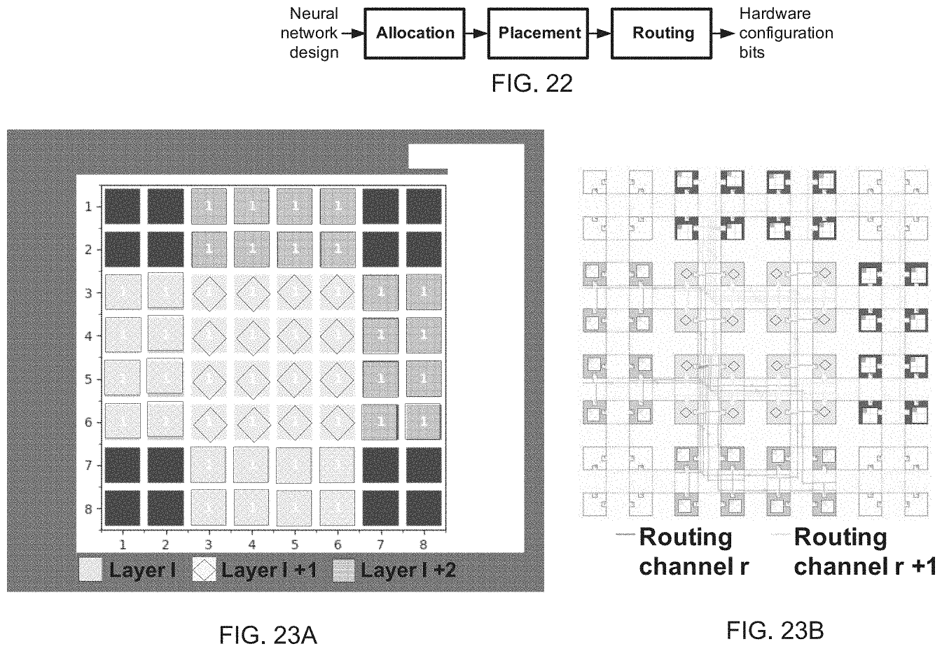

FIG. 22 graphically depicts three stages of mapping software flow to an architecture, illustratively, a NN mapping flow being mapped onto an 8×8 array of CIMUs. FIG. 23A depicts a sample placement of layers from a pipeline segment, and FIG. 23B depicts a sample routing from a pipeline segment.

Specifically, the benchmarks are mapped to each architecture via a software flow. For the IMC-based architecture, the mapping of software flow involves the three stages shown in FIG. 22; namely, allocation, placement, and routing.

Allocation corresponds to allocating CIMUs to NN layers in different pipeline segments, based on the filter mapping, layer unrolling, and BPBS unrolling such as previously described.

Placement corresponds to mapping the CIMUs allocated in each pipeline segment to physical CIMU locations within the architecture (such as depicted in FIG. 23A). This employs a simulated-annealing algorithm to minimize the activation-network segments required between transmitting and receiving CIMU. A sample placement of layers from a pipeline segment is shown in FIG. 23A.

Routing corresponds to configuring the routing resources within the on-chip network to move activations between CIMU (e.g., on-chip network portions forming an inter-CIMU network). This employs dynamic programming to minimize the activation-network segments required between transmitting and receiving CIMU, under the routing resource constraints. A sample routing from a pipeline segment is shown in FIG. 23B.

Following each stage of the mapping flow, functionality is verified using a behavioral model, which is also verified against the RTL design. After the three stages, configuration data are output, which are loaded to RTL simulations for final design verification. The behavioral model is cycle accurate, enabling energy and speed characterization based on modeling of the parameters above.

For the digital architecture, the application-mapping flow involves typical layer-by-layer mapping, with replication to maximize hardware utilization. Again, a cycle-accurate behavioral model is used to verify functionality and perform energy and speed characterization based on the modeling above.

### Architecture Scalability Evaluation—Energy, Throughput, and Latency Analysis

There is an increase in energy efficiency of the IMC-based architecture as compared to the digital architecture. In particular, 12-25× gains and 17-27× gains are achieved in the IMC-based architecture for batch size of 1 and 128, respectively, across the benchmarks. This suggests that matrix-loading energy has been substantially amortized and column utilization has been enhanced as a result of layer and BPBS unrolling.

There is an increase in throughput of the IMC-based architecture compared to the digital architecture. In particular, 1.3-4.3× gains and 2.2-5.0× gains are achieved in the IMC-based architecture for batch size of 1 and 128, respectively, across the benchmarks. The throughput gains are more modest than the energy-efficiency gains. A reason for this is that layer unrolling effectively incurs lost utilization of IMC hardware used for mapping later layers in each pipeline segment. Indeed, this effect is most significant for small batch sizes, and somewhat less for large batch sizes, where pipeline loading delay is amortized. However, even with large batches, some delay is required in CNNs to clear the pipeline between inputs, in order to avoid overlap of convolutional kernels across different inputs.

There is a reduction in latency of the IMC-based architecture compared to the digital architecture. The reductions seen track the throughput gains and follow the same rationale.

### Architecture Scalability Evaluation—Impacts of Layer and BPBS Unrolling

To analyze the benefits of layer unrolling, the ratio of the total amount of weight loading required in the IMC architecture with layer-by-layer mapping compared to layer unrolling is considered. It has been determined by the inventors that layer unrolling yields substantial reduction in weight loading, especially with architectural scale-up. More specifically, with IMC banks scaling from 4×4, 8×8, to 16×16, weight loading accounts for 28%, 46%, and 73% of the average total energy with layer-by-layer mapping (batch size of 1). On the other hand, weight loading accounts for just 23%, 24%, and 27% of the average total energy with layer unrolling (batch size of 1), enabling much better scalability. In contrast, conventional layer-by-layer mapping is acceptable in the digital architecture, accounting for 1.3%, 1.4%, and 1.9% of the average total energy (batch size of 1), due to the significantly higher energy of MVMs compared to IMC.

To analyze the benefits of BPBS unrolling, the factor decrease in the ratio of unused IMC cells is considered. This is shown in FIG. 18 for both column merging (as physical and effective utilization gain) as well as duplication and shifting. As seen, significant reductions in the ratio of unused bit cells are achieved. The total average bit cell utilization (effective) for column merging as well as duplication and shifting is 82.2% and 80.8%, respectively.

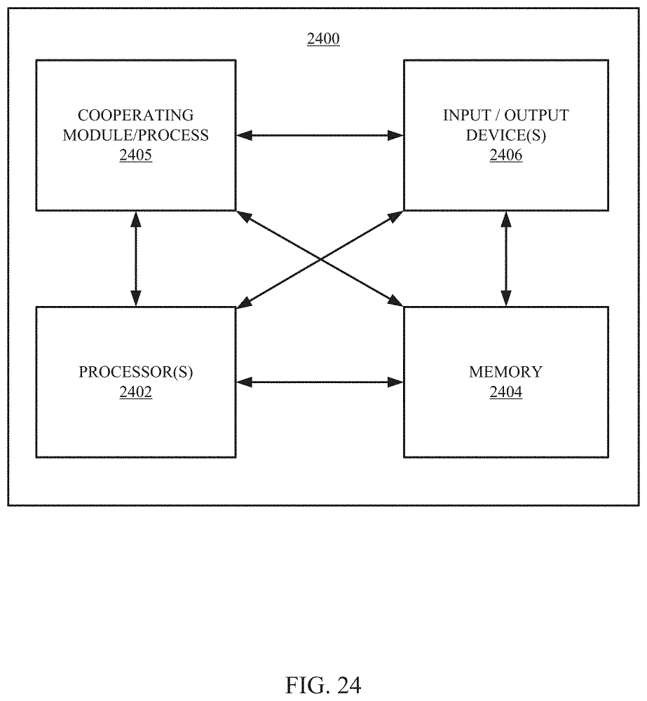

FIG. 24 depicts a high-level block diagram of a computing device suitable for use in implementing various control elements or portions thereof, and suitable for use in performing functions described herein such as those associated with the various elements described herein with respect to the figures.

For example, NN and application mapping tools and various application programs as depicted above may be implemented using a general purpose computing architecture such as depicted herein with respect to FIG. 24.

As depicted in FIG. 24, computing device 2400 includes a processor element 2402 (e.g., a central processing unit (CPU) or other suitable processor(s)), a memory 2404 (e.g., random access memory (RAM), read only memory (ROM), and the like), a cooperating module/process 2405, and various input/output devices 2406 (e.g., communications modules, network interface modules, receivers, transmitters and the like).

It will be appreciated that the functions depicted and described herein may be implemented in hardware or in a combination of software and hardware, e.g., using a general purpose computer, one or more application specific integrated circuits (ASIC), or any other hardware equivalents. In one embodiment, the cooperating process 2405 can be loaded into memory 2404 and executed by processor(s) 2402 to implement the functions as discussed herein. Thus, cooperating process 2405 (including associated data) can be stored on a computer readable storage medium, e.g., RAM memory, magnetic or optical drive or diskette, and the like.

It will be appreciated that computing device 2400 depicted in FIG. 24 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory device, or stored within a memory within a computing device operating according to the instructions.

Various embodiments contemplate computer implemented tools, application programs, systems and the like configured for mapping, design, testing, operation and/or other functions associated with the embodiments described herein. For example, the computing device of FIG. 24 may be used to provide computer implemented methods of mapping an application, NN, or other function to an integrated in-memory computing (IMC) architecture such as described herein.

As noted above with respect to FIGS. 22-23, mapping software flow or an application, NN, or other function to IMC hardware/architecture generally comprises three stages; namely, allocation, placement, and routing. Allocation corresponds to allocating CIMUs to NN layers in different pipeline segments, based on the filter mapping, layer unrolling, and BPBS unrolling such as previously described. Placement corresponds to mapping the CIMUs allocated in each pipeline segment to physical CIMU locations within the architecture. Routing corresponds to configuring the routing resources within the on-chip network to move activations between CIMU (e.g., on-chip network portions forming an inter-CIMU network).

Broadly speaking, these computer implemented methods may accept input data descriptive of a desired/target application, NN, or other function, and responsively generate output data of a form suitable for use programming or configuring an IMC architecture such that the desired/target application, NN, or other function is realized. This may be provided for a default IMC architecture or for a target IMC architecture (or portion thereof).

The computer implemented methods may employ various known tools and techniques, such as computational graphs, dataflow representations, high/mid/low level descriptors and the like to characterize, define, or describe a desired/target application, NN, or other function in terms of input date, operations, sequencing of operations, output data and the like.

The computer implemented methods may be configured to map the characterized, defined, or described application, NN, or other function onto an IMC architecture by allocating IMC hardware as appropriate, and to do so in a manner that substantially maximizes throughput and energy efficiency of the IMC hardware executing the application (e.g., by using the various techniques discussed herein, such as parallelism and pipelining of the computation using the IMC hardware). The computer implemented methods may be configured for utilizing some or all of the functions described herein, such as mapping neural networks to a tiled array of in-memory computing hardware; perform an allocation of in-memory-computing hardware to the specific computations required in neural networks; perform placement of allocated in-memory-computing hardware to specific locations in the tiled array (optionally where that placement is set to minimize the distance between in-memory-computing hardware providing certain outputs and in-memory-computing hardware taking certain inputs); employ optimization methods to minimize such distance (e.g., simulated annealing); perform configuration of the available routing resources to transfer outputs from in-memory-computing hardware to inputs to in-memory-computing hardware in the tiled array; minimize the total amount of routing resources required to achieve routing between the placed in-memory-computing hardware; and/or employ optimization methods to minimize such routing resources (e.g., dynamic programming).

FIG. 34 depicts a flow diagram of a method according to an embodiment. Specifically, FIG. 34 depicts a computer implemented method of mapping an application to an integrated in-memory computing (IMC) architecture, the IMC architecture comprising a plurality of configurable Compute-In-Memory Units (CIMUs) forming an array of CIMUs, and a configurable on-chip network for communicating input data to the array of CIMUs, communicating computed data between CIMUs, and communicating output data from the array of CIMUs.

The method of FIG. 34 is directed to generating a computational graph, dataflow map, and/or other mechanism/tool suitable for use in programming an application or NN into a IMC architecture such as discussed above. The method generally performs various configuration, mapping, optimization, and other steps as described above. In particular, the method is depicted as the steps of: allocating IMC hardware according to computational requirements of application or NN, defining placement of allocated IMC hardware to locations in the imc core array a manner tending to minimize a distance between IMC hardware generating output data and IMC hardware processing the generated output data, configuring the on-chip network to route the data between IMC hardware, configuring input/output buffers, shortcut buffers, and other hardware, applying BPBS unrolling as discussed above (e.g., duplication and shifting, column replication, other techniques), applying replication optimizations, layering optimizations, spatial optimizations, temporal optimizations, pipeline optimizations, and so on. The various calculations, optimizations, determinations, and the like may be implemented in any logical sequence and may be iterated or repeated to arrive at solution, whereupon a dataflow map may be generated for use in programming an IMC architecture.

In one embodiment, a computer implemented method of mapping an application to configurable in-memory computing (IMC) hardware of an integrated IMC architecture, the IMC hardware comprising a plurality of configurable Compute-In-Memory Units (CIMUs) forming an array of CIMUs, and a configurable on-chip network for communicating input data to the array of CIMUs, communicating computed data between CIMUs, and communicating output data from the array of CIMUs, the method comprising: allocating IMC hardware according to application computations, using parallelism and pipelining of IMC hardware, to generate an IMC hardware allocation configured to provide high throughput application computation; defining placement of allocated IMC hardware to locations in the array of CIMUs in a manner tending to minimize a distance between IMC hardware generating output data and IMC hardware processing the generated output data; and configuring the on-chip network to route the data between IMC hardware. The application may comprise a NN. The various steps may be implemented in accordance with the mapping techniques discussed throughout this application.

Various modifications may be made to the computer implemented method, such as by using the various mapping and optimizing techniques described herein. For example, an application, NN, or function may be mapped onto the IMC such that parallel output computed data of configured CIMUs executing at a given layer are provided to configured CIMUs executing at a next layer, such as where the parallel output computed data forms respective NN feature-map pixels. Further, computation pipelining may be supported by allocating a larger number of configured CIMUs executing at the given layer than at the next layer to compensate for a larger computation time at the given layer than at the next layer.

It will be appreciated that the functions depicted and described herein may be implemented in hardware or in a combination of software and hardware, e.g., using a general purpose computer, one or more application specific integrated circuits (ASIC), or any other hardware equivalents. It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

While specific systems, apparatus, methodologies, mechanisms and the like have been disclosed as discussed above, it should be apparent to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. In addition, the references listed herein are also part of the application and are incorporated by reference in their entirety as if fully set forth herein.

### Discussion of Exemplary IMC Core/CIMU

Various embodiments of an IMC Core or CIMU may be used within the context of the various embodiments. Such IMC Cores//CIMUs integrate configurability and hardware support around in-memory computing accelerators to enable programmability and virtualization required for broadening to practical applications. Generally, in-memory computing implements matrix-vector multiplication, where matrix elements are stored in the memory array, and vector elements are broadcast in parallel fashion over the memory array. Several aspects of the embodiments are directed toward enabling programmability and configurability of such an architecture:

In-memory computing typically involves 1-b representation for either the matrix elements, vector elements, or both. This is because the memory stores data in independent bit-cells, to which broadcast is done in a parallel homogeneous fashion, without provision for the different binary weighted coupling between bits required for multi-bit compute. In this invention, extension to multi-bit matrix and vector elements is achieved via a bit-parallel/bit-serial (BPBS) scheme.

To enable common compute operations that often surround matrix-vector multiplication, a highly-configurable/programmable near-memory-computing data path is included. This both enables computations required to extend from bit-wise computations of in-memory computing to multi-bit computations, and, for generality, this supports multi-bit operations, no longer constrained to the 1-b representations inherent for in-memory computing. Since programmable/configurable and multi-bit computing is more efficient in the digital domain, in this invention analog-to-digital conversion is performed following in-memory computing, and, in the particular embodiment, the configurable datapath is multiplexed among eight ADC/in-memory-computing channels, though other multiplexing ratios can be employed. This also aligns well with the BPBS scheme employed for multi-bit matrix-element support, where support up to 8-b operands is provided in the embodiment.

Since input-vector sparsity is common in many linear-algebra applications, this invention integrates support to enable energy-proportional sparsity control. This is achieved by masking the broadcasting of bits from the input vector, which correspond to zero-valued elements (such masking is done for all bits in the bit-serial process). This saves broadcast energy as well as compute energy within the memory array.

Given the internal bit-wise compute architecture for in-memory computing and the external digital-word architecture of typical microprocessors, data-reshaping hardware is used both for the compute interface, through which input vectors are provided, and for the memory interface through which matrix elements are written and read.

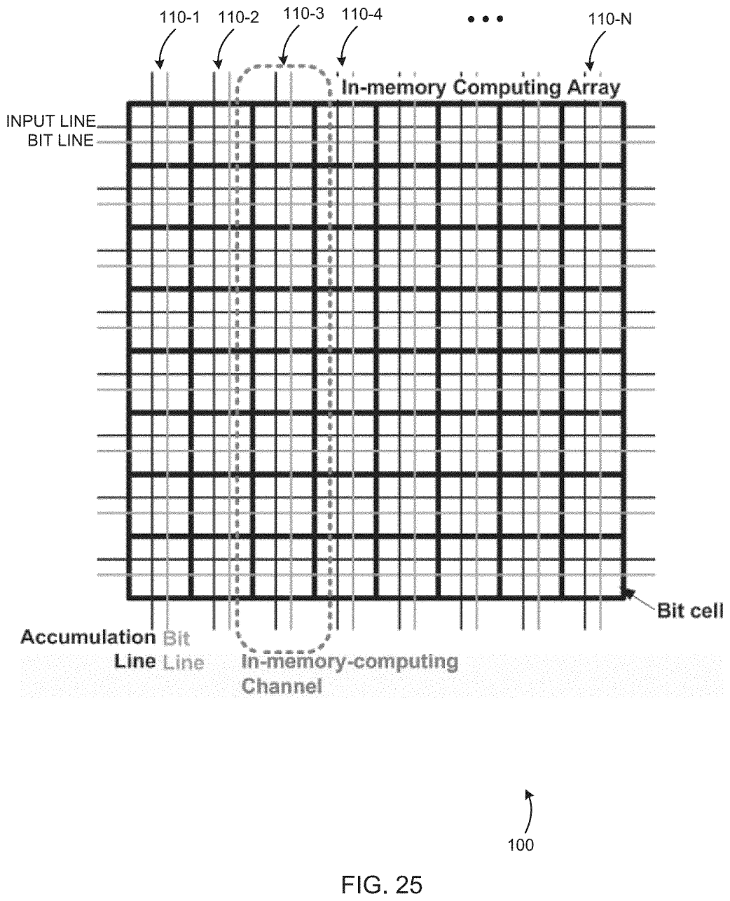

FIG. 25 depicts a typical structure of an in-memory computing architecture. Consisting of a memory array (which could be based on standard bit-cells or modified bit-cells), in-memory computing involves two additional, “perpendicular” sets of signals; namely, (1) input lines; and (2) accumulation lines. Referring to FIG. 25, it can be seen that a two-dimensional array of bit cells is depicted, where each of a plurality of in-memory-computing channels 110 comprises a respective column of bit-cells where each of the bit cells a channel is associated with a common accumulation line and bit line (column), and a respective input line and word line (row). It is noted that the columns and rows of signals are denoted herein as being “perpendicular” with respect to each other to simply indicate a row/column relationship within the context of an array of bit cells such as the two-dimensional array of bit-cells depicted in FIG. 25. The term “perpendicular” as used herein is not intended to convey any specific geometric relationship.

The input/bit and accumulation/bit sets of signals may be physically combined with existing signals within the memory (e.g., word lines, bit lines) or could be separate. For implementing matrix-vector multiplication, the matrix elements are first loaded in the memory cells. Then, multiple input-vector elements (possibly all) are applied at once via the input lines. This causes a local compute operation, typically some form of multiplication, to occur at each of the memory bit-cells. The results of the compute operations are then driven onto the shared accumulation lines. In this way, the accumulation lines represent a computational result over the multiple bit-cells activated by input-vector elements. This is in contrast to standard memory accessing, where bit-cells are accessed via bit lines one at a time, activated by a single word line.

In-memory computing as described, has a number of important attributes. First, compute is typically analog. This because the constrained structure of memory and bit-cells requires richer compute models than enabled by simple digital switch-based abstractions. Second, the local operation at the bit-cells typically involves compute with a 1-b representation stored in the bit-cell. This is because the bit-cells in a standard memory array do not couple with each other in any binary-weighted fashion; any such coupling must be achieved by methods of bit-cell accessing/readout from the periphery. Below, the extensions on in-memory computing proposed in the invention are described.

### Extension to Near-Memory and Multi-Bit Compute.

While in-memory computing has the potential to address matrix-vector multiplication in a manner that conventional digital acceleration falls short, typical compute pipelines will involve a range of other operations surrounding matrix-vector multiplication. Typically, such operations are well addressed by conventional digital acceleration; nonetheless, it may be of high value to place such acceleration hardware near the in-memory-compute hardware, in an appropriate architecture to address the parallel nature, high throughput (and thus need for high communication bandwidth to/from), and general compute patterns associated with in-memory computing. Since much of the surrounding operations will preferably be done in the digital domain, analog-to-digital conversion via ADCs is included following each of the in-memory computing accumulation lines, which we thus refer to as an in-memory-computing channels. A primary challenge is integrating the ADC hardware in the pitch of each in-memory-computing channel, but proper layout approaches taken in this invention enable this.

Introducing an ADC following each compute channel enables efficient ways of extending in-memory compute to support multi-bit matrix and vector elements, via bit-parallel/bit-serial (BPBS) compute, respectively. Bit-parallel compute involves loading the different matrix-element bits in different in-memory-computing columns. The ADC outputs from the different columns are then appropriately bit shifted to represent the corresponding bit weighting, and digital accumulation over all of the columns is performed to yield the multi-bit matrix-element compute result. Bit-serial compute, on the other hand, involves apply each bit of the vector elements one at a time, storing the ADC outputs each time and bit shifting the stored outputs appropriately, before digital accumulation with the next outputs corresponding to subsequent input-vector bits. Such a BPBS approach, enabling a hybrid of analog and digital compute, is highly efficient since it exploits the high-efficiency low-precision regime of analog (1-b) with the high-efficiency high-precision regime of digital (multi-bit), while overcoming the accessing costs associated with conventional memory operations.

While a range of near-memory computing hardware can be considered, details of the hardware integrated in the current embodiment of the invention are described below. To ease the physical layout of such multi-bit digital hardware, eight in-memory-computing channels are multiplexed to each near-memory computing channel. We note that this enables the highly-parallel operation of in-memory computing to be throughput matched with the high-frequency operation of digital near-memory computing (highly-parallel analog in-memory computing operates at lower clock frequency than digital near-memory computing). Each near-memory-computing channel then includes digital barrel shifters, multipliers, accumulators, as well as look-up-table (LUT) and fixed non-linear function implementations. Additionally, configurable finite-state machines (FSMs) associated with the near-memory computing hardware are integrated to control computation through the hardware.

### Input Interfacing and Bit-Scalability Control

For integrating in-memory computing with a programmable microprocessor, the internal bit-wise operations and representations must be appropriately interfaced with the external multi-bit representations employed in typical microprocessor architectures. Thus, data reshaping buffers are included at both the input-vector interface and the memory read/write interface, through which matrix elements are stored in the memory array. Details of the design employed for the invention embodiment are described below. The data reshaping buffers enable bit-width scalability of the input-vector elements, while maintaining maximal bandwidth of data transfer to the in-memory computing hardware, between it and external memories as well as other architectural blocks. The data reshaping buffers consist of register files that serving as line buffers receiving incoming parallel multi-bit data element-by-element for an input vector, and providing outgoing parallel single-bit data for all vector elements.

In addition to word-wise/bit-wise interfacing, hardware support is also included for convolutional operations applied to input vectors. Such operations are prominent in convolutional-neural networks (CNNs). In this case, matrix-vector multiplication is performed with only a subset of new vector elements needing to be provided (other input-vector elements are stored in the buffers and simply shifted appropriately). This mitigates bandwidth constraints for getting data to the high-throughput in-memory-computing hardware. In the invention embodiment, the convolutional support hardware, which must perform proper bit-serial sequencing of the multi-bit input-vector elements, is implemented within specialized buffers whose output readout properly shifts data for configurable convolutional striding.

### Dimensionality and Sparsity Control

For programmability, two additional considerations must be addressed by the hardware: (1) matrix/vector dimensions can be variable across applications; and (2) in many applications the vectors will be sparse.

Regarding dimensionality, in-memory computing hardware often integrates control to enable/disable tiled portions of an array, to consume energy only for the dimensionality levels desired in an application. But, in the BPBS approach employed, input-vector dimensionality has important implications on the computation energy and SNR. Regarding SNR, with bit-wise compute in each in-memory-computing channel, presuming the computation between each input (provided on an input line) and the data stored in a bit-cell yields a one-bit output, the number of distinct levels possible on an accumulation line is equal to N+1, where N is the input-vector dimensionality. This suggests the need for a log 2(N+1) bit ADC. However, an ADC has energy cost that scales strongly with the number of bits. Thus, it may be beneficial to support very large N, but fewer than log 2(N+1) bits in the ADC, to reduce the relative contribution of the ADC energy. The result of doing this is that the signal-to-quantization-noise ratio (SQNR) of the compute operation is different than standard fixed-precision compute, and is reduced with the number of ADC bits. Thus, to support varying application-level dimensionality and SQNR requirements, with corresponding energy consumption, hardware support for configurable input-vector dimensionality is essential. For instance, if reduced SQNR can be tolerated, large-dimensional input-vector segments should be support; on the other hand, if high SQNR must be maintained, lower-dimensional input-vector segments should be supported, with inner-product results from multiple input-vector segments combinable from different in-memory-computing banks (in particular, input-vector dimensionality could thus be reduced to a level set by the number of ADC bits, to ensure compute ideally matched with standard fixed-precision operation). The hybrid analog/digital approach taken in the invention enables this. Namely, input-vector elements can be masked to filter broadcast to only the desired dimensionality. This saves broadcast energy and bit-cell compute energy, proportionally with the input-vector dimensionality.

Regarding sparsity, the same masking approach can be applied throughout the bit-serial operations to prevent broadcasting of all input-vector element bits that correspond to zero-valued elements. We note that the BPBS approach employed is particularly conducive to this. This is because, while the expected number of non-zero elements is often known in sparse-linear-algebra applications, the input-vector dimensionalities can be large. The BPBS approach thus allows us to increase the input-vector dimensionality, while still ensuring the number of levels required to be supported on the accumulation lines is within the ADC resolution, thereby ensuring high computational SQNR. While the expected number of non-zero elements is known, it is still essential to support variable number of actual non-zero elements, which can be different from input vector to input vector. This is readily achieved in the hybrid analog/digital approach, since the masking hardware has simply to count the number of zero-value elements for the given vector, and then apply a corresponding offset to the final inner-product result, in the digital domain after BPBS operation.

### Exemplary Integrated Circuit Architecture

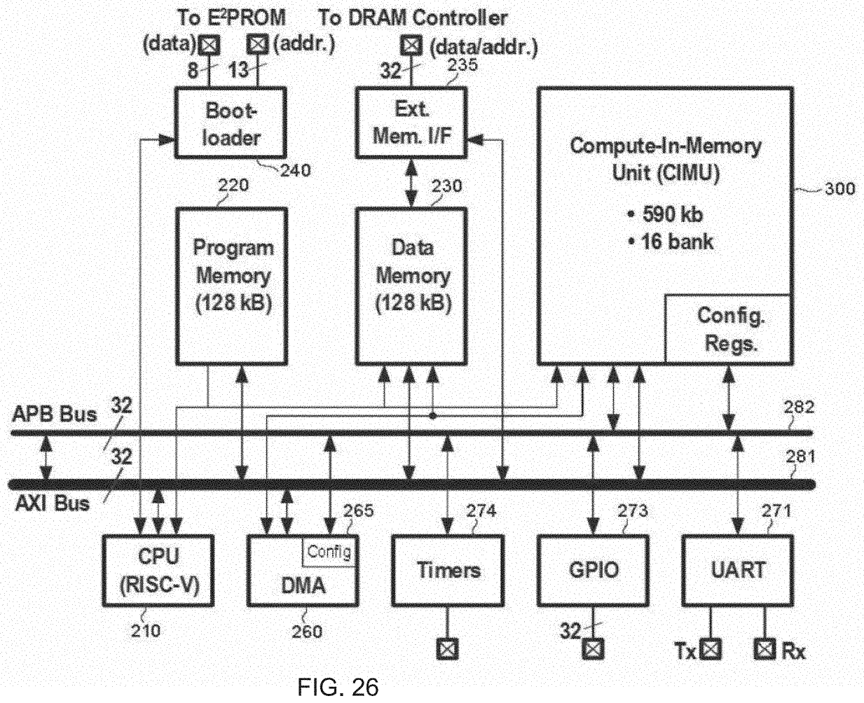

FIG. 26 depicts a high level block diagram of an exemplary architecture according to an embodiment. Specifically, the exemplary architecture of FIG. 26 was implemented as an integrated circuit using VLSI fabrication techniques using specific components and functional elements so as to test the various embodiments herein. It will be appreciated that further embodiments with different components (e.g., larger or more powerful CPUs, memory elements, processing elements and so on) are contemplated by the inventors to be within the scope of this disclosure.

As depicted in FIG. 26, the architecture 200 comprises a central processing unit (CPU) 210 (e.g., a 32-bit RISC-V CPU), a program memory (PMEM) 220 (e.g., a 128 KB program memory), a data memory (DMEM) 230 (e.g., a 128 KB data memory), an external memory interface 235 (e.g., configured to access, illustratively, one or more 32-bit external memory devices (not shown) to thereby extend accessible memory), a bootloader module 240 (e.g., configured to access an 8 KB off-chip EEPROM (not shown)), a computation-in-memory unit (CIMU) 300 including various configuration registers 255 and configured to perform in-memory computing and various other functions in accordance with the embodiments described herein, a direct-memory-access (DMA) module 260 including various configuration registers 265, and various support/peripheral modules, such as a Universal Asynchronous Receiver/Transmitter (UART) module 271 for receiving/transmitting data, a general purpose input/output (GPIO) module 273, various timers 274 and the like. Other elements not depicted herein may also be included in the architecture 200 of FIG. 26, such as SoC config modules (not shown) and so on.

The CIMU 300 is very well suited to matrix-vector multiplication and the like; however, other types of computations/calculations may be more suitably performed by non-CIMU computational apparatus. Therefore, in various embodiments a close proximity coupling between the CIMU 300 and near memory is provided such that the selection of computational apparatus tasked with specific computations and/or functions may be controlled to provide a more efficient compute function.

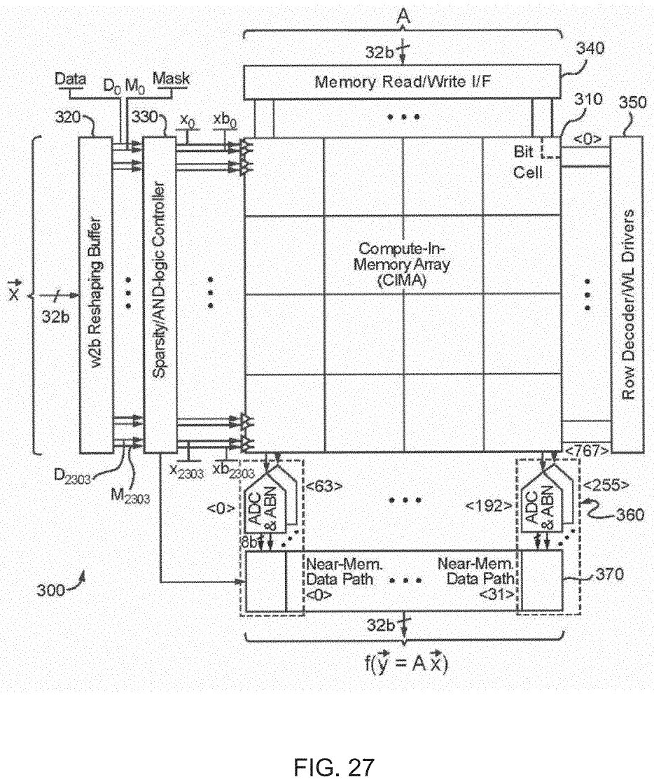

FIG. 27 depicts a high level block diagram of an exemplary Compute-In-Memory-Unit (CIMU) 300 suitable for use in the architecture of FIG. 26. The following discussion relates to the architecture 200 of FIG. 26 as well as the exemplary CIMU 300 suitable for use within the context of that architecture 200.

Generally speaking, the CIMU 300 comprises various structural elements including a computation-in-memory array (CIMA) of bit-cells configured via, illustratively, various configuration registers to provide thereby programmable in-memory computational functions such as matrix-vector multiplications and the like. In particular, the exemplary CIMU 300 is configured as a 590 kb, 16 bank CIMU tasked with multiplying an input matrix Xby an input vector A to produce an output matrix Y.

Referring to FIG. 27, the CIMU 300 is depicted as including a computation-in-memory array (CIMA) 310, an Input-Activation Vector Reshaping Buffer (IA BUFF) 320, a sparsity/AND-logic controller 330, a memory read/write interface 340, row decoder/WL drivers 350, a plurality of A/D converters 360 and a near-memory-computing multiply-shift-accumulate data path (NMD) 370.

The illustrative computation-in-memory array (CIMA) 310 comprises a 256×(3×3×256) computation-in-memory array arranged as 4×4 clock-gateable 64×(3×3×64) in-memory-computing arrays, thus having a total of 256 in-memory computing channels (e.g., memory columns), where there are also included 256 ADCs 360 to support the in-memory-computing channels.

The IA BUFF 320 operates to receive a sequence of, illustratively, 32-bit data words and reshapes these 32-bit data words into a sequence of high dimensionality vectors suitable for processing by the CIMA 310. It is noted that data words of 32-bits, 64-bits or any other width may be reshaped to conform to the available or selected size of the compute in memory array 310, which itself is configured to operate on high dimensionality vectors and comprises elements which may be 2-8 bits, 1-8 bits or some other size and applies them in parallel across the array. It is also noted that the matrix-vector multiplication operation described herein is depicted as utilizing the entirety of the CIMA 310; however, in various embodiments only a portion of the CIMA 310 is used. Further, in various other embodiments the CIMA 310 and associated logic circuitry is adapted to provide and interleaved matrix-vector multiplication operation wherein parallel portions of the matrix are simultaneously processed by respective portions of the CIMA 310.

In particular, the IA BUFF 320 reshapes the sequence of 32-bit data words into highly parallel data structures which may be added to the CIMA 310 at once (or at least in larger chunks) and properly sequenced in a bit-serial manner. For example, a four bit compute having eight vector elements may be associated with a high dimensionality vector of over 2000 n-bit data elements. The IA BUFF 320 forms this data structure.

As depicted herein the IA BUFF 320 is configured to receive the input matrix X as a sequence of, illustratively, 32-bit data words and resize/reposition the sequence of received data words in accordance with the size of the CIMA 310, illustratively to provide a data structure comprising 2303 n-bit data elements. Each of these 2303 n-bit data elements, along with a respective masking bit, is communicated from the IA BUFF 320 to the sparsity/AND-logic controller 330.

The sparsity/AND-logic controller 330 is configured to receive the, illustratively, 2303 n-bit data elements and respective masking bits and responsively invoke a sparsity function wherein zero value data elements (such as indicated by respective masking bits) are not propagated to the CIMA 310 for processing. In this manner, the energy otherwise necessary for the processing of such bits by the CIMA 310 is conserved.

In operation, the CPU 210 reads the PMEM 220 and bootloader 240 through a direct data path implemented in a standard manner. The CPU 210 may access DMEM 230, IA BUFF 320 and memory read/write buffer 340 through a direct data path implemented in a standard manner. All these memory modules/buffers, CPU 210 and DMA module 260 are connected by AXI bus 281. Chip configuration modules and other peripheral modules are grouped by APB bus 282, which is attached to the AXI bus 281 as a slave. The CPU 210 is configured to write to the PMEM 220 through AXI bus 281. The DMA module 260 is configured to access DMEM 230, IA BUFF 320, memory read/write buffer 340 and NMD 370 through dedicated data paths, and to access all the other accessible memory space through the AXI/APB bus such as per DMA controller 265. The CIMU 300 performs the BPBS matrix-vector multiplication described above. Further details of these and other embodiments are provided below.

Thus, in various embodiments, the CIMA operates in a bit serial bit parallel (BSBP) manner to receive vector information, perform matrix-vector multiplication, and provide a digitized output signal (i.e., Y=AX) which may be further processed by another compute function as appropriate to provide a compound matrix-vector multiplication function. Generally speaking, the embodiments described herein provide an in-memory computing architecture, comprising: a reshaping buffer, configured to reshape a sequence of received data words to form massively parallel bit-wise input signals; a compute-in-memory (CIM) array of bit-cells configured to receive the massively parallel bit-wise input signals via a first CIM array dimension and to receive one or more accumulation signals via a second CIM array dimension, wherein each of a plurality of bit-cells associated with a common accumulation signal forms a respective CIM channel configured to provide a respective output signal; analog-to-digital converter (ADC) circuitry configured to process the plurality of CIM channel output signals to provide thereby a sequence of multi-bit output words; control circuitry configured to cause the CIM array to perform a multi-bit computing operation on the input and accumulation signals using single-bit internal circuits and signals; and a near-memory computing path configured to provide the sequence of multi-bit output words as a computing result.

### Memory Map and Programming Model

Since the CPU 210 is configured to access the IA BUFF 320 and memory read/write buffer 340 directly, these two memory spaces look similar to the DMEM 230 from the perspective of a user program and in term of latency and energy, especially for structured data such as array/matrix data and the like. In various embodiments, when the in-memory computing feature is not activated or partially activated, the memory read/write buffer 340 and CIMA 310 may be used as normal data memory.

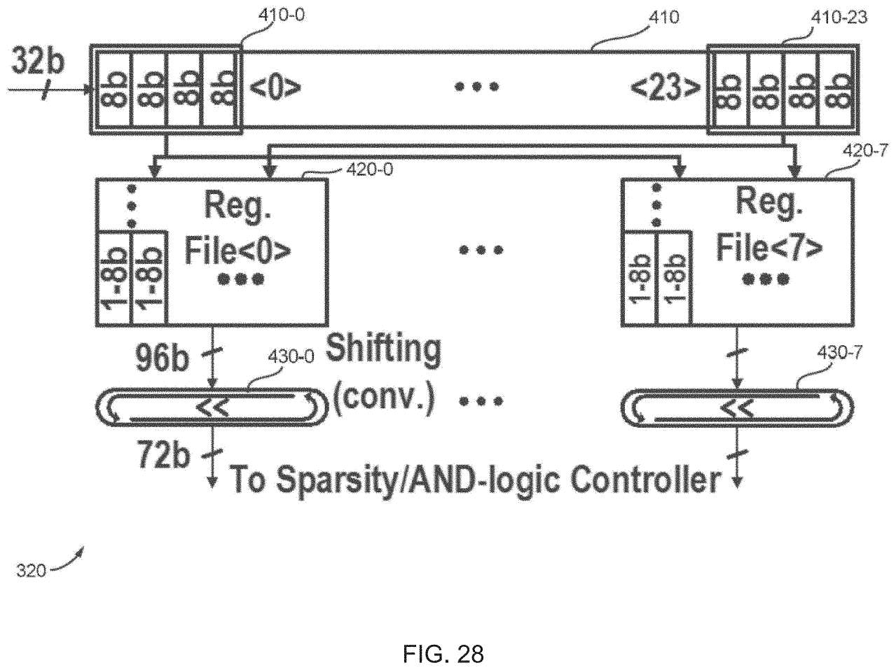

FIG. 28 depicts a high level block diagram of an Input-Activation Vector Reshaping Buffer (IA BUFF) 320 according to an embodiment and suitable for use in the architecture of FIG. 26. The depicted IA BUFF 320 supports input-activation vectors with element precision from 1 bit to 8 bits; other precisions may also be accommodated in various embodiments. According to a bit-serial flow mechanism discussed herein, a particular bit of all elements in an input-activation vector are broadcast at once to the CIMA 310 for a matrix-vector multiplication operation. However, the highly-parallel nature of this operation requires that elements of the high-dimensionality input-activation vector be provided with maximum bandwidth and minimum energy, otherwise the throughput and energy efficiency benefits of in-memory computing would not be harnessed. To achieve this, the input-activation reshaping buffer (IA BUFF) 320 may be constructed as follows, so that in-memory computing can be integrated in a 32-bit (or other bit-width) architecture of a microprocessor, whereby hardware for the corresponding 32-bit data transfers is maximally utilized for the highly-parallel internal organization of in-memory computing.

Referring to FIG. 28, the IA BUFF 320 receives 32-bit input signals, which may contain input-vector elements of bit precision from 1 to 8 bits. Thus the 32-bit input signals are first stored in 4×8-b registers 410, of which there are a total of 24 (denoted herein as registers 410-0 through 410-23). These registers 410 provide their contents to 8 register files (denoted as register files 420-0 through 420-8), each of which has 96 columns, and where the input vector, with dimensionality up to 3×3×256=2304, is arranged with its elements in parallel columns. This is done in the case of 8-b input elements, by the 24 4×8-b registers 410 providing 96 parallel outputs spanning one of the register files 420, and in the case of 1-b input elements, by the 24 4×8-b registers 410 providing 1536 parallel outputs, spanning all eight register files 420 (or with intermediate configurations for other bit precisions). The height of each register-file column is 2×4×8-b, allowing each input vector (with element precision up to 8 bits) to be stored in 4 segments, and enabling double buffering, for cases where all input-vector elements are to be loaded. On the other hand, for cases where as few as one-third of the input-vector elements are to be loaded (i.e., CNN with stride of 1), one out of every four register-file columns serves as a buffer, allowing data from the other three columns to be propagated forward to the CIMU for computation.

Thus, of the 96 columns output by each register file 420, only 72 are selected by a respective circular barrel-shifting interface 430, giving a total of 576 outputs across the 8 register files 420 at once. These outputs correspond to one of the four input-vector segments stored in the register files. Thus, four cycles are required to load all the input-vector elements into the sparsity/AND-logic controller 330, within 1-b registers.

To exploit sparsity in input-activation vector, a mask bit is generated for each data element while the CPU 210 or DMA 260 writes into the reshaping buffer 320. The masked input-activation prevents charge-based computation operations in the CIMA 310, which saves computation energy. The mask vector is also stored in SRAM blocks, organized similarly as the input-activation vector, but with one-bit representation.

The 4-to-3 barrel-shifter 430 is used to support VGG style (3×3 filter) CNN computation. Only one of three of the input-activation vectors needs to be updated when moving to the next filtering operation (convolutional reuse), which saves energy and enhances throughput.

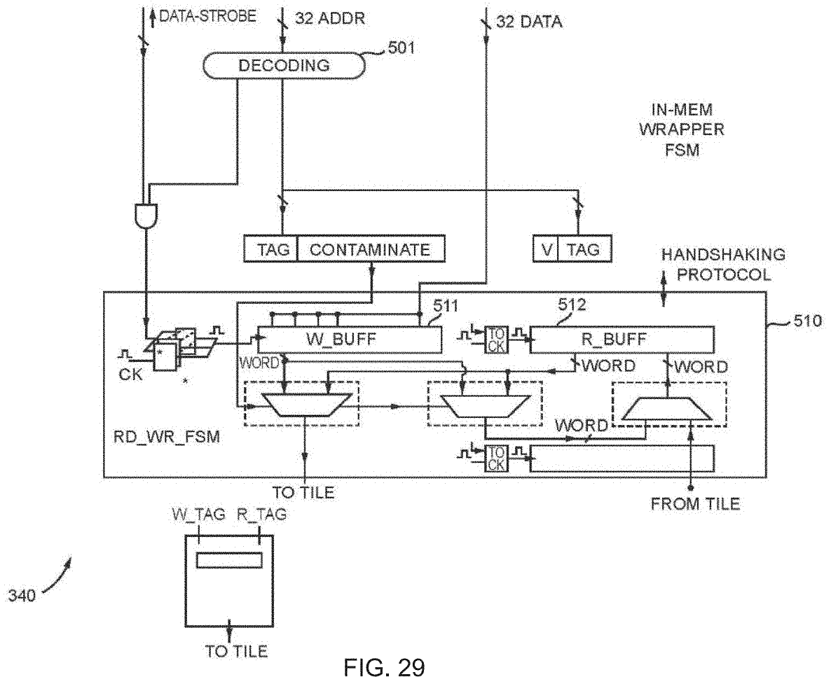

FIG. 29 depicts a high level block diagram of a CIMA Read/Write Buffer 340 according to an embodiment and suitable for use in the architecture of FIG. 26. The depicted CIMA Read/Write Buffer 340 is organized as, illustratively, a 768-bit wide static random access memory (SRAM) block 510, while the word width of the depicted CPU is 32-bit in this example; a read/write buffer 340 is used to interface therebetween.

The read/write buffer 340 as depicted contains a 768-bit write register 511 and 768-bit read register 512. The read/write buffer 340 generally acts like a cache to the wide SRAM block in CIMA 310; however, some details are different. For example, the read/write buffer 340 writes back to CIMA 310 only when the CPU 210 writes to a different row, while reading a different row does not trigger write-back. When the reading address matches with the tag of write register, the modified bytes (indicated by contaminate bits) in the write register 511 are bypassed to the read register 512, instead of reading from CIMA 310.

Accumulation-line Analog-to-digital Converters (ADCs). The accumulations lines from the CIMA 310 each have an 8-bit SAR ADC, fitting into the pitch of the in-memory-computing channel. To save area, a finite-state machine (FSM) controlling bit-cycling of the SAR ADCs is shared among the 64 ADCs required in each in-memory-computing tile. The FSM control logic consists of 8+2 shift registers, generating pulses to cycle through the reset, sampling, and then 8 bit-decision phases. The shift-register pulses are broadcast to the 64 ADCs, where they are locally buffered, used to trigger the local comparator decision, store the corresponding bit decision in the local ADC-code register, and then trigger the next capacitor-DAC configuration. High-precision metal-oxide-metal (MOM) caps may be used enable small size of each ADC's capacitor array.

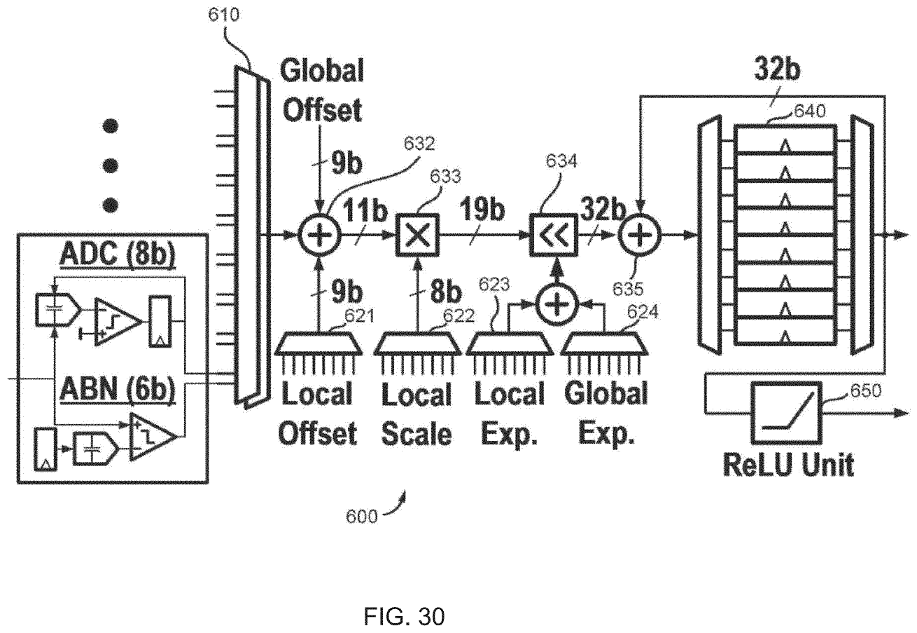

FIG. 30 depicts a high level block diagram of a Near-Memory Datapath (NMD) Module 600 according to an embodiment and suitable for use in the architecture of FIG. 26, though digital near-memory computing with other features can be employed. The depicted NMD module 600 depicted in FIG. 30 shows a digital computation data path after ADC output which support multi-bit matrix multiplication via the BPB S scheme.

In the particular embodiment, 256 ADC outputs are organized into groups of 8 for the digital computation flow. This enables support of up to 8-bit matrix-element configuration. The NMD module 600 thus contains 32 identical NMD units. Each NMD unit consists of multiplexers 610/620 to select from 8 ADC outputs 610 and corresponding bias 621, multiplicands 622/623, shift numbers 624 and accumulation registers, an adder 631 with 8-bit unsigned input and 9-bit signed input to subtract the global bias and mask count, a signed adder 632 to compute local bias for neural network tasks, a fixed-point multiplier 633 to perform scaling, a barrel shifter 634 to compute the exponent of the multiplicand and perform shift for different bits in weight elements, a 32-bit signed adder 635 to perform accumulation, eight 32-bit accumulation registers 640 to support weight with 1, 2, 4 and 8-bit configurations, and a ReLU unit 650 for neural network applications.

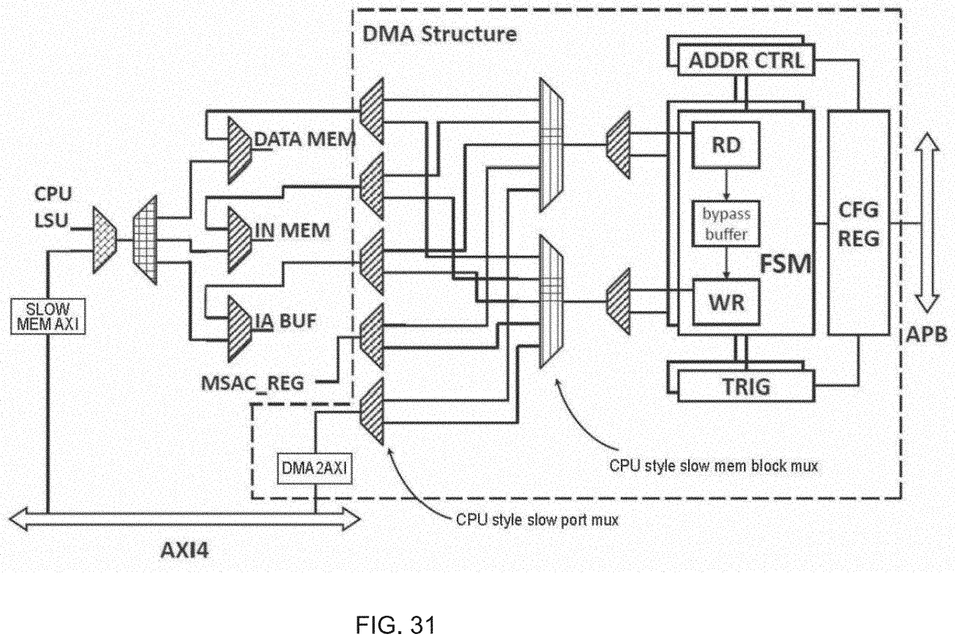

FIG. 31 depicts a high level block diagram of a direct memory access (DMA) module 700 according to an embodiment and suitable for use in the architecture of FIG. 26. The depicted DMA module 700 is comprises, illustratively, two channels to support data transferring from/to different hardware resources simultaneously, and 5 independent data paths from/to DMEM, IA BUFF, CIMU R/W BUFF, NMD result and AXI4 bus, respectively.

### Bit-Parallel/Bit-Serial (BPBS) Matrix-Vector Multiplication

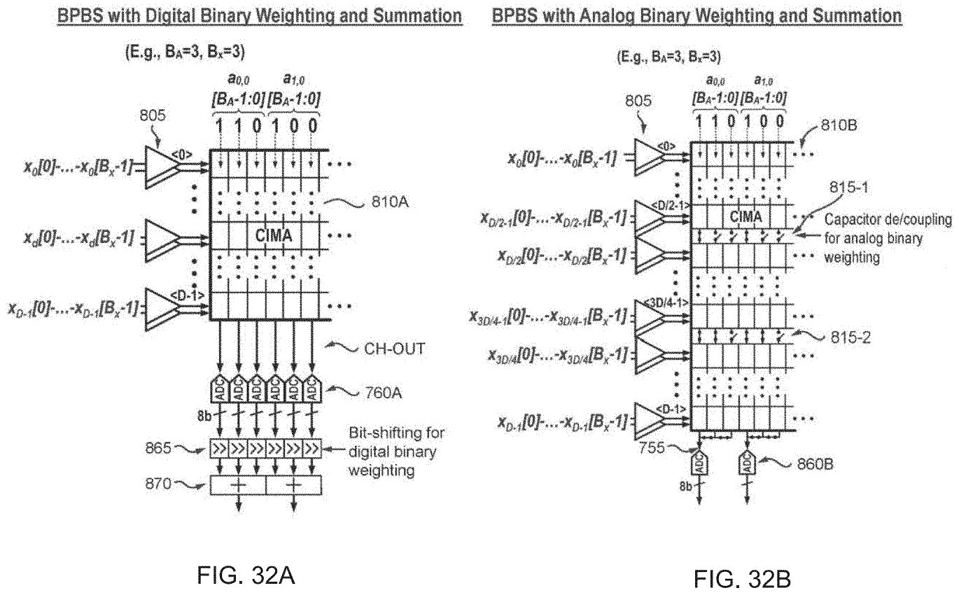

The BPBS scheme for multi-bit MVM \vec{y}=A\vec{x})=A\vec{x} is shown in FIG. 32, where BA corresponds to the number of bits used for the matrix elements a_{m,n}, Bx corresponds to the number of bits used for the input-vector elements xₙ, and N corresponds to the dimensionality of the input vector, which can be up to 2304 in the hardware of the embodiment (Mₙ is a mask bit, used for sparsity and dimensionality control). The multiple bits of a_{m,n} are mapped to parallel CIMA columns and the multiple bits of xₙ are inputted serially. Multi-bit multiplication and accumulation can then be achieved via in-memory computing either by bit-wise XNOR or by bit-wise AND, both of which are supported by the multiplying bit cell (M-BC) of the embodiment. Specifically, bit-wise AND differs from bit-wise XNOR in that the output should remain low when the input-vector-element bit is low. The M-BC of the embodiment involves inputting the input-vector-element bits (one at a time) as a differential signal. The M-BC implements XNOR, where each logic ‘1’ output in the truth table is achieved by driving to V_{DD} via the true and complement signals, respectively, of the input-vector-element bit. Thus, AND is easily achieved, simply by masking the complement signal, so that the output remains low to yield the truth-table corresponding to AND.

Bit-wise AND can support a standard 2's complement number representation for multi-bit matrix and input-vector elements. This involves properly applying a negative sign to the column computations corresponding to most-significant-bit (MSB) elements, in the digital domain after the ADC, before adding the digitized outputs to those of the other column computations.

Bit-wise XNOR requires slight modification of the number representation. I.e., element bits map to +1/−1 rather than I/O, necessitating two bits with equivalent LSB weighting to properly represent zero. This is done as follows. First, each B-bit operand (in standard 2's complement representation) is decomposed to a B+1-bit signed integer. For example, y decomposes into B+1 plus/minus-one bits —[y^{B-1}, y^{B-2} . . . , y¹, (y₁⁰, y₂⁰)], to yield y=Σᵢ₌₁^{B-1}2ⁱ·yⁱ+(y₁⁰+y₂⁰).

With 1/0-valued bits mapping to mathematical values of +1/−1, bit-wise in-memory-computing multiplication may be realized via a logical XNOR operation. The M-BC, performing logical XNOR using a differential signal for the input-vector element, can thus enable signed multi-bit multiplication by bit-weighting and adding the digitized outputs from column computations.

While the AND-based M-BC multiplication and XNOR-based M-BC multiplication present two options, other options are also possible, by using appropriate number representations with the logical operations possible in the M-BC. Such alternatives are beneficial. For example XNOR-based M-BC multiplication is preferred for binarized (1-b) computations while AND-based M-BC multiplication enables a more standard number representation to facilitate integration within digital architectures. Further, the two approaches yield slightly different signal-to-quantization noise ratio (SQNR), which can thus be selected based on application needs.

### Heterogeneous Computing Architecture and Interface

The various embodiments described herein contemplate different aspects of charge-domain in-memory computing where a bit-cell (or multiplying bit cell, M-BC) drives an output voltage corresponding to a computational result onto a local capacitor. The capacitors from an in-memory-computing channel (column) are then coupled to yield accumulation via charge redistribution. As noted above, such capacitors may be formed using a particular geometry that is very easy to replicate such as in a VLSI process, such as via wires that are simply close to each other and thus coupled via an electric field. Thus, a local bit-cell formed as a capacitor stores a charge representing a one or a zero, while adding up all of the charges of a number of these capacitors or bit-cells locally enables the implementation of the functions of multiplication and accumulation/summation, which is the core operation in matrix vector multiplication.

The various embodiments describe above advantageously provide improved bit-cell based architectures, computing engines and platforms. Matrix vector multiplication is one operation not performed efficiently by standard, digital processing or digital acceleration. Therefore, doing this one type of computation in memory gives a huge advantage over existing digital designs. However, various other types of operations are performed efficiently using digital designs.

Various embodiments contemplate mechanisms for connecting/interfacing these bit-cell based architectures, computing engines, platforms and the like to more conventional digital computing architectures and platforms such as to form a heterogenous computing architecture. In this manner, those compute operations well suited to bit-cell architecture processing (e.g., matrix vector processing) are processed as described above, while those other computing operations well suited to traditional computer processing are processed via traditional computer architecture. That is, various embodiments provide a computing architecture including a highly parallel processing mechanism as described herein, wherein this mechanism is connected to a plurality of interfaces so that it can be externally coupled to a more conventional digital computing architecture. In this way the digital computing architecture can be directly and efficiently aligned to the in-memory-computing architecture, allowing the two to be placed in close proximity to minimize data-movement overheads between them. For example, while a machine learning application may comprise 80% to 90% matrix vector computations, that still leaves 10% to 20% of other types of computations/operations to be performed. By combining the in memory computing discussed herein with near memory computing that is more conventional in architecture, the resulting system provides exceptional configurability to perform many types of processing. Therefore, various embodiments contemplate near-memory digital computations in conjunction with the in-memory computing described herein.

The in-memory computations discussed herein are massively parallel but single bit operations. For example, in a bit-cell only one bit may be stored. A one or a zero. The signal that is driven to the bit-cell is typically an input vector (i.e., each matrix element is multiplied by each vector element in a 2D vector multiplication operation). The vector element is put on a signal that is also digital and is only one bit such that the vector element is one bit as well.

Various embodiments extend matrices/vectors from one-bit elements to multiple bit elements using a bit-parallel/bit-serial approach.

FIGS. 8A-8B depict high level block diagrams of differing embodiments of CIMA channel digitization/weighting suitable for use in the architecture of FIG. 26. Specifically, FIG. 32A depicts a digital binary weighting and summation embodiment similar to that described above with respect to the various other figures. FIG. 32B depicts an analog binary weighting and summation embodiment with modifications made to various circuit elements to enable the use of fewer analog to digital converters than the embodiments of FIG. 32A and/or other embodiments described herein.

As previously discussed, various embodiments contemplate that a compute-in-memory (CIM) array of bit-cells is configured to receive massively parallel bit-wise input signals via a first CIM array dimension (e.g., rows of a 2D CIM array) and to receive one or more accumulation signals via a second CIM array dimension (e.g., columns of a 2D CIM array), wherein each of a plurality of bit-cells associated with a common accumulation signal (depicted as, e.g., a column of bit-cells) forms a respective CIM channel configured to provide a respective output signal. Analog-to-digital converter (ADC) circuitry is configured to process the plurality of CIM channel output signals to provide thereby a sequence of multi-bit output words. Control circuitry is configured to cause the CIM array to perform a multi-bit computing operation on the input and accumulation signals using single-bit internal circuits and signals such that a near-memory computing path operably engage thereby may be configured to provide the sequence of multi-bit output words as a computing result.

Referring to FIG. 32A, a digital binary weighting and summation embodiment performing the ADC circuitry function is depicted. In particular, a two dimensional CIMA 810A receives matrix input values at a first (rows) dimension (i.e., via a plurality of buffers 805) and vector input values at a second (columns) dimension, wherein the CIMA 810A operates in accordance with control circuitry and the like (not shown) to provide various channel output signals CH-OUT.

The ADC circuitry of FIG. 32A provides, for each CIM channel, a respective ADC 760 configured to digitize the CIM channel output signal CH-OUT and a respective shift register 865 configured to impart a respective binary weighting to the digitized CIM channel output signal CH-OUT to form thereby a respective portion of a multi-bit output word 870.

Referring to FIG. 32B, an analog binary weighting and summation embodiment performing the ADC circuitry function is depicted. In particular, a two dimensional CIMA 810B receives matrix input values at a first (rows) dimension (i.e., via a plurality of buffers 805) and vector input values at a second (columns) dimension, wherein the CIMA 810B operates in accordance with control circuitry and the like (not shown) to provide various channel output signals CH-OUT.

The ADC circuitry of FIG. 32B provides four controllable (or preset) banks of switches 815-1, 815-2 and so on within the CIMA 810B operate to couple and/or decouple capacitors formed therein to implement thereby an analog binary weighting scheme for each of one or more subgroups of channels, wherein each of the channel subgroups provides a single output signal such that only one ADC 860B is required to digitize a weighted analog summation of the CIM channel output signals of the respective subset of CIM channels to form thereby a respective portion of a multi-bit output word.

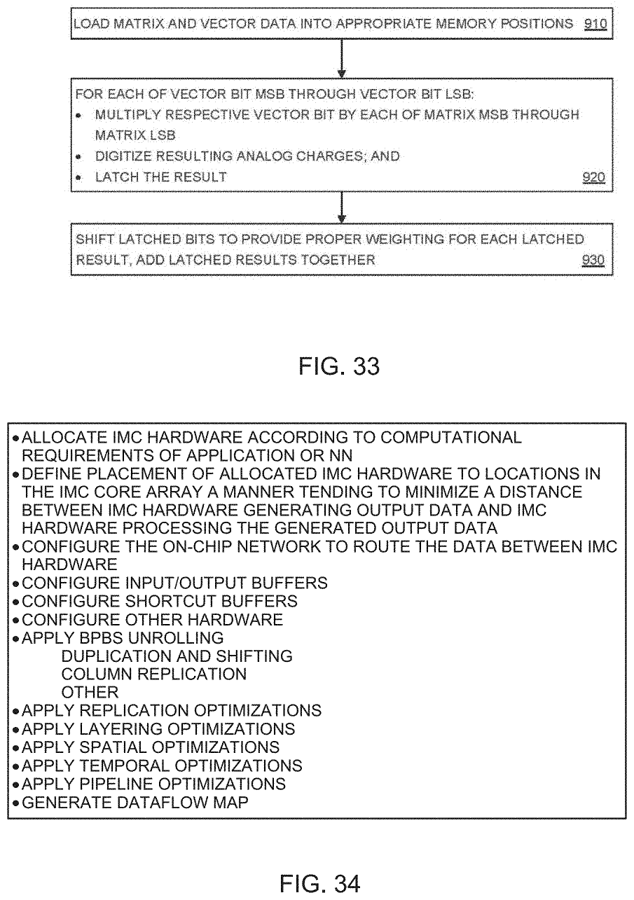

FIG. 33 depicts a flow diagram of a method according to an embodiment. Specifically, the method 900 of FIG. 33 is directed to the various processing operations implemented by the architectures, systems and so on as described herein wherein an input matrix/vector is extended to be computed in a bit parallel/bit serial approach.

At step 910, the matrix and vector data are loaded into appropriate memory locations.

At step 920, each of the vector bits (MSB through LSB) is sequentially processed. Specifically, the MSB of the vector is multiplied by the MSB of the matrix, the MSB of the vector is multiplied by the MSB-1 of the matrix, the MSB of the vector multiplied by the MSB-2 of the matrix and so on through to the MSB of the vector multiplied by the LSB of the matrix. The resulting analog charge results are then digitized for each of the MSB through LSB vector multiplications to get a result, which is latched. This process is repeated for the vector MSB-1, vector MSB-2 and so on through the vector LSB until such time as the each of the vector MSB-LSB has been multiplied by each of the MSB-LSB elements of the matrix.

At step 930, the bits are shifted to apply a proper weighting and the results added together. It is noted that in some of the embodiments where analog weighting is used, the shifting operation of step 930 is unnecessary.

Various embodiments enable highly stable and robust computations to be performed within a circuit used to store data in dense memories. Further, various embodiments advance the computing engine and platform described herein by enabling higher density for the memory bit-cell circuit. The density can be increased both due to a more compact layout and because of enhanced compatibility of that layout with highly-aggressive design rules used for memory circuits (i.e., push rules). The various embodiments substantially enhance the performance of processors for machine learning, and other linear algebra.

Disclosed is a bit-cell circuit which can be used within an in-memory computing architecture. The disclosed approach enables highly stable/robust computation to be performed within a circuit used to store data in dense memories. The disclosed approach for robust in memory computing enables higher density for the memory bit-cell circuit than known approaches. The density can be higher both due to a more compact layout and because of enhanced compatibility of that layout with highly-aggressive design rules used for memory circuits (i.e., push rules). The disclosed device can be fabricated using standard CMOS integrated circuit processing.

### Partial List of Disclosed Embodiments

Aspects of various embodiments are specified in the claims. Those and other aspects of at least a subset of the various embodiments are specified in the following numbered clauses:

1. An integrated in-memory computing (IMC) architecture configurable to support dataflow of an application mapped thereto, comprising: a configurable plurality of Compute-In-Memory Units (CIMUs) forming an array of CIMUs, said CIMUs being configured to communicate activations to/from other CIMUs or other structures within or outside the CIMU array via respective configurable inter-CIMU network portions disposed therebetween, and to communicate weights to/from other CIMUs or other structures within or outside the CIMU array via respective configurable operand loading network portions disposed therebetween.

2. The integrated IMC architecture of clause 1, wherein each CIMU comprises a configurable input buffer for receiving computational data from the inter-CIMU network and composing the received computational data into an input vector for matrix vector multiplication (MVM) processing by the CIMU to generate thereby an output feature vector.

3. The integrated IMC architecture of clause 1, wherein each CIMU comprises a configurable input buffer for receiving computational data from the inter-CIMU network, each CIMU composing received computational data into an input vector for matrix vector multiplication (MVM) processing to generate thereby an output feature vector.

4. The integrated IMC architecture of clauses 2 or 3, wherein each CIMU comprises is associated with a configurable shortcut buffer, for receiving computational data from the inter-CIMU network, imparting a temporal delay to the received computational data, and forwarding the delayed computation data toward a next CIMU in accordance with a dataflow map.

5. The integrated IMC architecture of clauses 2 or 3, wherein each CIMU is associated with a configurable shortcut buffer, for receiving computational data from the inter-CIMU network, and imparting a temporal delay to the received computational data, and forwarding the delayed computation data toward the configurable input buffer.

6. The integrated IMC architecture of clauses 2 or 3, wherein each CIMU is includes parallelized computation hardware configured for processing input data received from at least one of respective input and shortcut buffers.

7. The integrated IMC architecture of clauses 4 or 5, wherein each CIMU shortcut buffer is configured in accordance with a dataflow map such that dataflow alignment across multiple CIMUs is maintained.

8. The integrated IMC architecture of clauses 4 or 5, wherein the shortcut buffer of each of a plurality of CIMUs in the array of CIMUs is configured in accordance with a dataflow map supporting pixel-level pipelining to provide pipeline latency matching.

9. The integrated IMC architecture of clauses 4 or 5, wherein the temporal delay imparted by a shortcut buffer of a CIMU comprises at least one of an absolute temporal delay, a predetermined temporal delay, a temporal delay determined with respect to a size of input computational data, a temporal delay determined with respect to an expected computational time of the CIMU, a control signal received from a dataflow controller, a control signal received from another CIMU, and a control signal generated by the CIMU in response to the occurrence of an event within the CIMU.

10. The integrated IMC architecture of clauses 4 or 5 or 6, wherein each configurable input buffer is capable of imparting a temporal delay to computational data received from the inter-CIMU network or shortcut buffer.

11. The integrated IMC architecture of clause 10, wherein the temporal delay imparted by a configurable input buffer of a CIMU comprises at least one of an absolute temporal delay, a predetermined temporal delay, a temporal delay determined with respect to a size of input computational data, a temporal delay determined with respect to an expected computational time of the CIMU, a control signal received from a dataflow controller, a control signal received from another CIMU, and a control signal generated by the CIMU in response to the occurrence of an event within the CIMU.

12. The integrated IMC architecture of clause 1, wherein at least a subset of the CIMUs, the inter-CIMU network portions and the operand loading network portions are configured in accordance with a dataflow of an application mapped onto the IMC.

13. The integrated IMC architecture of clause 9, wherein at least a subset of the CIMUs, the inter-CIMU network portions and the operand loading network portions are configured in accordance with a dataflow of a layer by layer mapping of a neural network (NN) onto the IMC such that parallel output activations computed by configured CIMUs executing at a given layer are provided to configured CIMUs executing at a next layer, said parallel output activations forming respective NN feature-map pixels.

14. The integrated IMC architecture of clause 13, wherein the configurable input buffer is configured for transferring the input NN feature-map data to parallelized computation hardware within the CIMU in accordance with a selected stride step.

15. The integrated IMC architecture of clause 14, wherein the NN comprises a convolution neural network (CNN), and the input line buffer is used to buffer a number of rows of an input feature map corresponding to a size of the CNN kernel.

16. The integrated IMC architecture of clauses 2 or 3, wherein each CIMU comprises an in-memory computing (IMC) bank configured to perform matrix vector multiplication (MVM) in accordance with a bit-parallel, bit-serial (BPBS) computing process in which single bit computations are performed using an iterative barrel shifting with column weighting process, followed by a results accumulation process.

17. The integrated IMC architecture of clauses 2 or 3, wherein each CIMU comprises an in-memory computing (IMC) bank configured to perform matrix vector multiplication (MVM) in accordance with a bit-parallel, bit-serial (BPBS) computing process in which single bit computations are performed using an iterative column merging with column weighting process, followed by a results accumulation process.

18. The integrated IMC architecture of clauses 2 or 3, wherein each CIMU comprises an in-memory computing (IMC) bank configured to perform matrix vector multiplication (MVM) in accordance with a bit-parallel, bit-serial (BPBS) computing process in which elements of the IMC bank are allocated using a BPBS unrolling process.

19. The integrated IMC architecture of clause 18, wherein IMC bank elements are is further configured to perform said MVM using a duplication and shifting process.

20. The integrated IMC architecture of clauses 4 or 5, wherein each CIMU is associated with a respective near-memory, programmable single-instruction multiple-data (SIMD) digital engine, the SIMD digital engine suitable for use in combining or temporally aligning input buffer data, shortcut buffer data, and/or output feature vector data for inclusion within a feature vector map.

21. The integrated IMC architecture of clause 20, wherein at least a portion of the CIMUs are associated with a respective lookup table for mapping inputs to outputs in accordance with a plurality of non-linear functions, wherein non-linear function output data is provided to the SIMD digital engine associated with the respective CIMU.

22. The integrated IMC architecture of clause 20, wherein at least a portion of the CIMUs are associated with a parallel lookup table for mapping inputs to outputs in accordance with a plurality of non-linear functions, wherein non-linear function output data is provided to the SIMD digital engine associated with the respective CIMU.

23. An in-memory computing (IMC) architecture for mapping a neural network (NN) thereto, comprising:

an on-chip array of Compute-In-Memory Units (CIMUs) logically configurable as elements within layers of a NN mapped thereto, wherein each CIMU output activation comprises a respective feature-vector supporting a respective portion of a dataflow associated with a mapped NN, and wherein parallel output activations computed by CIMUs executing at a given layer form a feature-map pixel;

an on-chip activation network configured to communicate CIMU output activations between adjacent CIMUs, wherein parallel output activations computed by CIMUs executing at a given layer form a feature-map pixel;

an on-chip operand loading network to communicate weights to adjacent CIMUs via respective weight-loading interfaces therebetween.

24. Any of the clauses above, modified as needed to provide a dataflow architecture for in-memory computing where computational inputs and outputs pass from one in-memory-computing block to the next, via a configurable on-chip network.

25. Any of the clauses above, modified as needed to provide a dataflow architecture for in-memory computing where an in-memory computing module may receive inputs from multiple in-memory computing modules and may provide outputs to multiple in-memory computing modules.

26. Any of the clauses above, modified as needed to provide a dataflow architecture for in-memory computing where proper buffering is provided at the input or output of in-memory computing modules, to enable inputs and outputs to flow between modules in a synchronized manner.

27. Any of the clauses above, modified as needed to provide a dataflow architecture where parallel data, corresponding to output channels for a particular pixel in the output feature map of a neural network, are passed from one in-memory-computing block to the next.

28. Any of the clauses above, modified as needed to provide a method of mapping neural-network computations to in-memory computing where neural-network weights are stored as matrix elements in memory, with memory columns corresponding to different output channels.

29. Any of the clauses above, modified as needed to provide a method of mapping neural-network computations to in-memory-computing hardware where the matrix elements stored in memory may be changed over the course of a computation.

30. Any of the clauses above, modified as needed to provide a method of mapping neural-network computations to in-memory-computing hardware where the matrix elements stored in memory may be stored in multiple in-memory computing modules or locations.

31. Any of the clauses above, modified as needed to provide a method of mapping neural-network computations to in-memory-computing hardware where multiple neural-network layers are mapped at a time (layer unrolling).

32. Any of the clauses above, modified as needed to provide a method of mapping neural-network computations to in-memory-computing hardware performing bit-wise operations, where different matrix-element bits are mapped to the same column (BPBS unrolling).

33. Any of the clauses above, modified as needed to provide a method of mapping multiple matrix-element bits to the same column where higher-order bits are replicated to enable proper analog weighting (column merging).

34. Any of the clauses above, modified as needed to provide a method of mapping multiple matrix-element bits to the same column where elements are duplicated and shifted, and higher-order input-vector elements are provided to rows with shifted elements (duplication and shifting).

35. Any of the clauses above, modified as needed to provide a method of mapping neural-network computations to in-memory computing hardware performing bit-wise operations, but where multiple input-vector bits are provided simultaneously, as a multi-level (analog) signal.

36. Any of the clauses above, modified as needed to provide a method for multi-level input-vector element signaling, where a multi-level driver is employs dedicated voltage supplies, selected by decoding multiple bits of the input-vector element.

37. Any of the clauses above, modified as needed to provide a multi-level driver where the dedicated supplies can be configured from off-chip (e.g., to support number formats for XNOR computation and computation).

38. Any of the clauses above, modified as needed to provide a modular architecture for in-memory computing where modular tiles are arrayed together to achieve scale-up.

39. Any of the clauses above, modified as needed to provide a modular architecture for in-memory computing where the modules are connected by a configurable on-chip network.

40. Any of the clauses above, modified as needed to provide a modular architecture for in-memory computing where the modules comprise any one or a combination of the modules described herein.

41. Any of the clauses above, modified as needed to provide control and configuration logic to properly configure the module and provide proper localized control.

42. Any of the clauses above, modified as needed to provide input buffers for receiving data to be computed on by the module.

43. Any of the clauses above, modified as needed to provide a buffer for providing delay of input data to properly synchronize data flow through the architecture.

44. Any of the clauses above, modified as needed to provide local near-memory computation.

45. Any of the clauses above, modified as needed to provide buffers either within modules or as separate modules for synchronizing data flow through the architecture.

46. Any of the clauses above, modified as needed to provide a near-memory digital computing, located close to in-memory computing hardware, which provides programmable/configurable parallel computations on the output data from in-memory computing.

47. Any of the clauses above, modified as needed to provide computation data paths between the parallel output data paths, to provide computation across different in-memory computing outputs (e.g., between adjacent in-memory-computing outputs).

48. Any of the clauses above, modified as needed to provide computation data paths for reducing data across all the parallel output data paths, in a hierarchical manner up to single outputs.

49. Any of the clauses above, modified as needed to provide computation data paths that can take inputs from auxiliary sources in addition to the in-memory computing outputs (e.g., short-cut buffer, computational units between input and short-cut buffers, and others).

50. Any of the clauses above, modified as needed to provide near-memory digital computing employing instruction-decoding and control hardware shared across parallel data paths applied to output data from in-memory computing.

51. Any of the clauses above, modified as needed to provide near memory data path providing configurable/controllable multiplication/division, addition/subtraction, bit-wise shifting, etc. operations.

52. Any of the clauses above, modified as needed to provide a near memory data path with local registers for intermediate computation results (scratch pad) and parameters.

53. Any of the clauses above, modified as needed to provide a method of computing arbitrary non-linear functions across the parallel data paths via a shared look-up table (LUT).

54. Any of the clauses above, modified as needed to provide sequential bit-wise broadcasting of look-up table (LUT) bits with local decoder for LUT decoding.

55. Any of the clauses above, modified as needed to provide input buffer located close to in-memory computing hardware, providing storage of input data to be processed by in-memory-computing hardware.

56. Any of the clauses above, modified as needed to provide input buffering enabling reuse of data for in-memory-computing (e.g., as required for convolution operations).

57. Any of the clauses above, modified as needed to provide input buffering where rows of input feature maps are buffered to enable convolutional reuse in two dimensions of a filter kernel (across the row and across multiple rows).

58. Any of the clauses above, modified as needed to provide input buffering allowing inputs to be taken from multiple input ports, so that in-coming data can be provided from multiple different sources.

59. Any of the clauses above, modified as needed to provide multiple different ways of arranging the data from the multiple different input ports, where, for example, one way might be to arrange the data from different input ports into different vertical segments of the buffered rows.

60. Any of the clauses above, modified as needed to provide an ability to access the data from the input buffer at multiples of the clock frequency, for providing to in-memory-computing hardware.

61. Any of the clauses above, modified as needed to provide additional buffering located close to in-memory-computing hardware or at separate locations in the tiled array of in-memory computing hardware, but not necessarily to provide data directly to in-memory-computing hardware.

62. Any of the clauses above, modified as needed to provide additional buffering to provide proper delaying of data, so that data from different in-memory-computing hardware can be properly synchronized (e.g., as in the case of short-cut connections in neural networks).

63. Any of the clauses above, modified as needed to provide additional buffering enabling reuse of data for in-memory-computing (e.g., as required for convolution operations), optionally Input buffering where rows of input feature maps are buffered to enable convolutional reuse in two dimensions of a filter kernel (across the row and across multiple rows).

64. Any of the clauses above, modified as needed to provide additional buffering allowing inputs to be taken from multiple input ports, so that in-coming data can be provided from multiple different sources.

65. Any of the clauses above, modified as needed to provide multiple different ways of arranging the data from the multiple different input ports, where, for example, one way might be to arrange the data from different input ports into different vertical segments of the buffered rows.

66. Any of the clauses above, modified as needed to provide input interfaces for in-memory-computing-hardware to take matrix elements to be stored in bit cells through an on-chip network.

67. Any of the clauses above, modified as needed to provide input interfaces for matrix element data that allow use of the same on-chip network for input-vector data.

68. Any of the clauses above, modified as needed to provide computational hardware between the input buffering and additional buffer close to in-memory-computing hardware.

69. Any of the clauses above, modified as needed to provide computational hardware that can provide parallel computations between outputs from the input and additional buffering.

70. Any of the clauses above, modified as needed to provide computational hardware that can provide computations between the outputs of the input and additional buffering.

71. Any of the clauses above, modified as needed to provide computational hardware whose outputs can feed the in-memory-computing hardware.

72. Any of the clauses above, modified as needed to provide computational hardware whose outputs can feed the near-memory-computing hardware following in-memory-computing hardware.

73. Any of the clauses above, modified as needed to provide on-chip network between in-memory-computing tiles, with modular structure where segments comprising parallel routing channels surround CIMU tiles.

74. Any of the clauses above, modified as needed to provide on-chip network comprising a number of routing channels, which can each take inputs from the in-memory-computing hardware and/or provide outputs to the in-memory-computing hardware.

75. Any of the clauses above, modified as needed to provide on-chip network comprising routing resources which can be used to provide data originating from any in-memory-computing hardware to any other in-memory computing hardware in a tiled array, and possibly to multiple different in-memory computing hardware

76. Any of the clauses above, modified as needed to provide an implementation of the on-chip network where in-memory-computing hardware provides data to the routing resources or takes data from the routing resources via multiplexing across the routing resources.

77. Any of the clauses above, modified as needed to provide an implementation of the on-chip network where connections between routing resources are made via a switching block at intersection points of the routing resources.

78. Any of the clauses above, modified as needed to provide a switching block that can provide complete switching between intersecting routing resources, or subset of complete switching between the intersecting routing resources.

79. Any of the clauses above, modified as needed to provide software for mapping neural networks to a tiled array of in-memory computing hardware.

80. Any of the clauses above, modified as needed to provide software tools that perform allocation of in-memory-computing hardware to the specific computations required in neural networks.

81. Any of the clauses above, modified as needed to provide software tools that perform placement of allocated in-memory-computing hardware to specific locations in the tiled array.

82. Any of the clauses above, modified as needed to provide software tools where that placement is set to minimize the distance between in-memory-computing hardware providing certain outputs and in-memory-computing hardware taking certain inputs.

83. Any of the clauses above, modified as needed to provide software tools employing optimization methods to minimize such distance (e.g., simulated annealing).

84. Any of the clauses above, modified as needed to provide software tools that perform configuration of the available routing resources to transfer outputs from in-memory-computing hardware to inputs to in-memory-computing hardware in the tiled array.

85. Any of the clauses above, modified as needed to provide software tools that minimize the total amount of routing resources required to achieve routing between the placed in-memory-computing hardware.

86. Any of the clauses above, modified as needed to provide software tools employing optimization methods to minimize such routing resources (e.g., dynamic programming).

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. An integrated in-memory computing (IMC) architecture configurable to support scalable execution and dataflow of an application mapped thereto, comprising:
a plurality of configurable Compute-In-Memory Units (CIMUs) forming an array of CIMUs; and
a configurable on-chip network for communicating input data to the array of CIMUs, communicating computed data between CIMUs, and communicating output data from the array of CIMUs.

2. The integrated IMC architecture of claim 1, wherein:
each CIMU comprises an input buffer for receiving computational data from the on-chip network and composing the received computational data into an input vector for matrix vector multiplication (MVM) processing by the CIMU to generate thereby computed data comprising an output vector.

3. The integrated IMC architecture of claim 2, wherein each CIMU is associated with a shortcut buffer, for receiving computational data from the on-chip network, imparting a temporal delay to the received computational data, and forwarding delayed computation data toward a next CIMU or an output in accordance with a dataflow map such that dataflow alignment across multiple CIMUs is maintained.

4. The integrated IMC architecture of claim 2, wherein each CIMU includes parallelized computation hardware configured for processing input data received from at least one of respective input and shortcut buffers.

5. The integrated IMC architecture of claim 3, wherein at least one of the input buffer and shortcut buffers of each of the plurality of CIMUs in the array of CIMUs is configured in accordance with a dataflow map supporting pixel-level pipelining to provide pipeline latency matching.

6. The integrated IMC architecture of claim 3, wherein the temporal delay imparted by a shortcut buffer of a CIMU comprises at least one of an absolute temporal delay, a predetermined temporal delay, a temporal delay determined with respect to a size of input computational data, a temporal delay determined with respect to an expected computational time of the CIMU, a control signal received from a dataflow controller, a control signal received from another CIMU, and a control signal generated by the CIMU in response to the occurrence of an event within the CIMU.

7. The integrated IMC architecture of claim 3, wherein at least some of the input buffers may be configured to impart a temporal delay to computational data received from the on-chip network or from a shortcut buffer.

8. The integrated IMC architecture of claim 7, wherein the temporal delay imparted by an input buffer of a CIMU comprises at least one of an absolute temporal delay, a predetermined temporal delay, a temporal delay determined with respect to a size of input computational data, a temporal delay determined with respect to an expected computational time of the CIMU, a control signal received from a dataflow controller, a control signal received from another CIMU, and a control signal generated by the CIMU in response to the occurrence of an event within the CIMU.

9. The integrated IMC architecture of claim 8, wherein at least a subset of the CIMUs are associated with on-chip network portions including operand loading network portions configured in accordance with a dataflow of an application mapped onto the IMC.

10. The integrated IMC architecture of claim 9, wherein the application mapped onto the IMC comprises a neural network (NN) mapped onto the IMC such that parallel output computed data of configured CIMUs executing at a given layer are provided to configured CIMUs executing at a next layer, said parallel output computed data forming respective NN feature-map pixels.

11. The integrated IMC architecture of claim 10, wherein the input buffer is configured for transferring input NN feature-map data to parallelized computation hardware within the CIMU in accordance with a selected stride step.

12. The integrated IMC architecture of claim 11, wherein the NN comprises a convolution neural network (CNN), and the input buffer is used to buffer a number of rows of an input feature map corresponding to a size of the CNN kernel.

13. The integrated IMC architecture of claim 2, wherein each CIMU comprises an in-memory computing (IMC) bank configured to perform matrix vector multiplication (MVM) in accordance with a bit-parallel, bit-serial (BPBS) computing process in which single bit computations are performed using an iterative barrel shifting with column weighting process, followed by a results accumulation process.

14. The integrated IMC architecture of claim 2, wherein each CIMU comprises an in-memory computing (IMC) bank configured to perform matrix vector multiplication (MVM) in accordance with a bit-parallel, bit-serial (BPBS) computing process in which single bit computations are performed using an iterative column merging with column weighting process, followed by a results accumulation process.

15. The integrated IMC architecture of claim 2, wherein each CIMU comprises an in-memory computing (IMC) bank configured to perform matrix vector multiplication (MVM) in accordance with a bit-parallel, bit-serial (BPBS) computing process in which elements of the IMC bank are allocated using a BPBS unrolling process.

16. The integrated IMC architecture of claim 15, wherein IMC bank elements are further configured to perform MVM using a duplication and shifting process.

17. The integrated IMC architecture of claim 15, wherein each CIMU is associated with a respective near-memory, programmable single-instruction multiple-data (SIMD) digital engine, the SIMD digital engine suitable for use in combining or temporally aligning input buffer data, shortcut buffer data, and/or output feature vector data for inclusion within a feature vector map.

18. The integrated IMC architecture of claim 15, wherein at least a portion of the CIMUs include respective lookup tables for mapping inputs to outputs in accordance with a plurality of non-linear functions, wherein non-linear function output data is provided to the SIMD digital engine associated with the respective CIMU.

19. The integrated IMC architecture of claim 15, wherein at least a portion of the CIMUs are associated with a parallel lookup table for mapping inputs to outputs in accordance with a plurality of non-linear functions, wherein non-linear function output data is provided to the SIMD digital engine associated with the respective CIMU.

20. The IMC architecture of claim 1, wherein each input comprises a multi-bit input, and wherein each multibit input value is represented by a respective voltage level.

21. An integrated in-memory computing (IMC) architecture configurable to support scalable execution and dataflow of a neural network (NN) mapped thereto, comprising:
a plurality of configurable Compute-In-Memory Units (CIMUs) forming an array of CIMUs logically configured as elements within layers of the NN mapped thereto, wherein each CIMU provides computed data output representing a respective portion of a vector within a dataflow associated with the mapped NN, and wherein parallel output computed data of CIMUs executing at a given layer form a feature-map pixel;
a configurable on-chip network for communicating input data to the array of CIMUs, communicating computed data between CIMUs, and communicating output data from the array of CIMUs, the on-chip network including an on-chip operand loading network to communicate operands between CIMUs via respective interfaces therebetween.

22. The IMC architecture of claim 21, wherein the mapping of neural-network computations to in-memory computing hardware operates to perform bit-wise operations, wherein multiple input-vector bits are provided simultaneously and represented via selected voltage levels of an analog signal.

23. The IMC architecture of claim 21, wherein a multi-level driver communicates an output signal from a selected one of a plurality of voltage sources, the voltage source being selected by decoding multiple bits of an input-vector element.

24. The IMC architecture of claim 20, wherein each input comprises a multi-bit input, and wherein each multibit input value is represented by a respective voltage level.

25. A computer implemented method of mapping an application to configurable in-memory computing (IMC) hardware of an integrated IMC architecture, the IMC hardware comprising a plurality of configurable Compute-In-Memory Units (CIMUs) forming an array of CIMUs, and a configurable on-chip network for communicating input data to the array of CIMUs, communicating computed data between CIMUs, and communicating output data from the array of CIMUs, the method comprising:
allocating IMC hardware according to application computations, using parallelism and pipelining of IMC hardware, to generate an IMC hardware allocation configured to provide high throughput application computation;
defining placement of allocated IMC hardware to locations in the array of CIMUs in a manner tending to minimize a distance between IMC hardware generating output data and IMC hardware processing the generated output data; and
configuring the on-chip network to route the data between IMC hardware.

26. The computer implemented method of claim 25, wherein the application mapped onto the IMC comprises a neural network (NN) mapped onto the IMC such that parallel output computed data of configured CIMUs executing at a given layer are provided to configured CIMUs executing at a next layer, said parallel output computed data forming respective NN feature-map pixels.

27. The computer implemented method of claim 25, wherein computation pipelining is supported by allocating a larger number of configured CIMUs executing at the given layer than at the next layer to compensate for a larger computation time at the given layer than at the next layer.
